(19) United States
(12) Patent Application Publication
(10) Pub. No.: US 2019/0265955 A1
(43) Pub. Date: Aug. 29, 2019

(54) METHOD AND SYSTEM FOR COMPARING SEQUENCES

(71) Applicant: Ramot at Tel-Aviv University Ltd., Tel-Aviv (IL)

(72) Inventor: Lior WOLF, Herzlia (IL)

(73) Assignee: Ramot at Tel-Aviv University Ltd., Tel-Aviv (IL)

(21) Appl. No.: 16/318,143

(22) PCT Filed: Jul. 21, 2017
(86) PCT No.: PCT/IL2017/050825

§ 371 Date: Jan. 16, 2019

Related U.S. Application Data
(60) Provisional application No. 62/364,974, filed on Jul. 21, 2016.

(51) Int. Cl. G06F 8/30; G06F 8/41; G06N 3/08

(52) U.S. Cl. CPC G06F 8/30; G06N 3/08; G06F 8/41

(57) ABSTRACT

A method of comparing sequences, comprises: inputting a first set of sequences and a second set of sequences; applying an encoder to each set to encode the set into a collection of vectors, each representing one sequence of the set; constructing a grid representation having a plurality of grid-elements, each comprises a vector pair composed of one vector from each of the collections; and feeding the grid representation into a convolutional neural network (CNN), constructed to simultaneously process all vector pairs of the grid representation, and to provide a grid output having a plurality of grid-elements, each defining a similarity level between vectors in one grid-element of the grid representation.

### RELATED APPLICATION

This application claims the benefit of priority of U.S. Provisional Patent Application No. 62/364,974 filed Jul. 21, 2016, the contents of which are incorporated herein by reference in their entirety

### FIELD AND BACKGROUND OF THE INVENTION

The present invention, in some embodiments thereof, relates to sequence analysis and, more particularly, but not exclusively, to a method and system for comparing sequences, such as, but not limited to, computer codes.

A program is a collection of instructions that instruct the computer to execute operations. A program is written in a human readable programming language, such as Visual Basic, C, C++ or Java, and the statements and commands written by the programmer are converted into a machine language by other programs known as “assemblers,” “compilers,” “interpreters,” and the like

In developing programs or software, the programmer typically generates several versions of a program in the process of developing a final product. Often times in writing a new version of a program, a programmer may desire to locate differences between the versions. The programmer may compare the two different versions looking at the new code and the old code to identify differences in lines of code between the two codes. When the codes are source codes written in a human readable language, it is possible to perform this comparison manually by humans, albeit the process may be extremely time-consuming and susceptible to human errors. For example, it may be difficult to compare statements containing loops and/or if-then-else constructs in multiple nestings, since they may have the same end statements. When one or both of the codes is provided after it has been converted to machine language (for example, when one or both of the codes is a compiled code) a manual comparison between the codes becomes impractical.

### SUMMARY OF THE INVENTION

According to an aspect of some embodiments of the present invention there is provided a method of comparing sequences. The method comprises: inputting a first set of sequences and a second set of sequences; applying an encoder to each set to encode the set into a collection of vectors, each representing one sequence of the set; constructing a grid representation having a plurality of grid-elements, each comprises a vector pair composed of one vector from each of the collections; and feeding the grid representation into a convolutional neural network (CNN), constructed to simultaneously process all vector pairs of the grid representation, and to provide a grid output having a plurality of grid-elements, each defining a similarity level between vectors in one grid-element of the grid representation.

According to some embodiments of the invention the encoder comprises a Recurrent Neural Network (RNN). According to some embodiments of the invention the RNN is a bi-directional RNN. According to some embodiments of the invention the encoder comprises a long short-term memory (LSTM) network.

According to some embodiments of the invention the CNN comprises a plurality of subnetworks, each being fed by one grid element of the grid representation.

According to some embodiments of the invention at least a portion of the plurality of subnetworks are replicas of each other. According to some embodiments of the invention at least a portion of the plurality of subnetworks operate independently.

According to some embodiments of the invention the method comprises concatenating the vector pair to a concatenated vector.

According to some embodiments of the invention the method comprises converting each sequence to a sequence of binary vectors, wherein the applying the encoder comprises feeding the binary vectors to the encoder.

According to some embodiments of the invention the method comprises concatenating the sequence of binary vectors prior to the feeding.

According to some embodiments of the invention the encoder is configured to provide, for each sequence, a single vector corresponding to a single representative token within the sequence.

According to some embodiments of the invention the method comprises redefining the first set of sequences and the second set of sequences such that each sequence of each set includes a single terminal token, wherein the single representative token is the single terminal token.

According to some embodiments of the invention each of the first and the second sets of sequences is a computer code.

According to some embodiments of the invention the first set of sequences is a programming language source code, and the second set of sequences is an object code.

According to some embodiments of the invention the object code is generated by compiler software applied to the programming language source code.

According to some embodiments of the invention the object code is generated by compiler software applied to another programming language source code which includes at least a portion of the programming language source code of the first set of sequences and at least one sub-code not present in the programming language source code of the first set of sequences.

According to some embodiments of the invention the first set of sequences is a first programming language source code, and the second set of sequences is a second programming language source code.

According to some embodiments of the invention the method wherein the second programming language source code is generated by a computer code translation software applied to the first programming language source code.

According to some embodiments of the invention the first set of sequences is a first object code, and the second set of sequences is a second object code.

According to some embodiments of the invention the first and the second object code are generated by different compilation processes applied to the same programming language source code.

According to some embodiments of the invention the method comprises generating an output pertaining to computer code statements that are present in a computer code forming the second set, but not in a computer code forming the first set.

According to some embodiments of the invention the method comprises identifying a sub-code formed by the computer code statements, and wherein the generating the output comprises identifying the sub-code as malicious.

According to an aspect of some embodiments of the present invention there is provided a computer software product, comprises a computer-readable medium in which program instructions are stored, which instructions, when read by a data processor, cause the data processor to receive a first set of sequences and a second set of sequences and to execute the method as delineated above and optionally and preferably as further detailed hereinbelow.

According to an aspect of some embodiments of the present invention there is provided a system for comparing sequences. The system comprises a hardware processor for executing computer program instructions stored on a computer-readable medium. The computer program instructions comprises: computer program instructions for inputting a first set of sequences and a second set of sequences; computer program instructions for applying an encoder to each set to encode the set into a collection of vectors, each representing one sequence of the set; computer program instructions for constructing a grid representation having a plurality of grid-elements, each comprises a vector pair composed of one vector from each of the collections; and computer program instructions for feeding the grid representation into a convolutional neural network (CNN), constructed to simultaneously process all vector pairs of the grid representation, and to provide a grid output having a plurality of grid-elements, each defining a similarity level between vectors in one grid-element of the grid representation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-C illustrate statement by statement alignment. FIG. 1A illustrates a sample C function, FIG. 1B illustrates the object code that results from compiling the C code, presented as assembly code, and FIG. 1C illustrates an alignment matrix, where the white cells indicate correspondence. The matrix represents the following object code→source code alignment: 1→2, 2→2, 3→3, 4→5, 5→5, 6→7, 7→5, 8→5, 9→5, 10→5, 11→5, 12→9, 13→10, 14→10.

FIGS. 2A-E illustrate the effect of compiler optimization levels on the resulting object code. FIG. 2A illustrates a sample C function, FIGS. 2B-E illustrate the alignment matrices for the object code that results from compiling the C code using the GCC compiler with optimization levels 0, 1, 2 and 3 respectively (the object code itself is not shown). The matching is much less monotonic post-optimization, and the optimization results in many source code statements that have been precomputed and removed. Also, for this specific code, the results of optimization levels 2 and 3 are identical.

FIG. 3 illustrates an architecture of a neural network used in experiments performed according to some embodiments of the present invention. The statements of the source code and the object code are each converted to a sequence of one-hot binary vectors. These sequences are concatenated and fed to the BiRNN (shown as rectangles). The BiRNN activations of the EOS element of each object code statement are compared with the ones from each source code statement by employing a fully connected network that is replicated across the grid (triangles). The similarities (s) that result from these comparisons are fed into one softmax function per each object code statement (elongated ellipses), which generates pseudo probabilities (p).

FIGS. 4A-C illustrate alignments predicted by the network of FIG. 3. Each row is one sample. The first sample is using -O1 optimization. The next two samples employ -O2, and the rest employ -O3. Each matrix cell varies between 0 (black) to 1 (white). FIG. 4A illustrates a soft prediction of the alignment, FIG. 4B illustrates a predicted hard-alignment, and FIG. 4C illustrates a ground truth. The soft predictions are mostly certain and the hard predictions match almost completely the ground truth.

FIGS. 5A and 5B illustrate alignment predictions for the case of statement duplication, both for the original (FIG. 5A) and altered source code (FIG. 5B). The duplicated statement is marked by an asterisk (*).

FIG. 6 shows alignment quality scores when matching the original source code to the object code and when matching the source code with the addition of a duplicated statement.

FIG. 7 shows results obtained by applying four alignment quality measurements on alignment matrices obtained when aligning a source code to the correct object code and to an alternative one. The shown results are averaged over 100 runs.

FIGS. 8A-C show samples of alignments before and after the insertions of simulated backdoors. The alignment matrix is shown before (top row) and after the insertion (bottom). In all three examples four object code statements were added. The optimization levels in FIGS. 8A-C are -O1, -O2 and -O3, respectively.

FIGS. 9A-D show ROC curves obtained for insertion of simulated backdoor code.

FIGS. 10A and 10B show AUC values vs. the size of simulated backdoor code for the four quality scores. FIG. 10A corresponds to code insertion, and FIG. 10B corresponds to code substitution.

FIG. 11 is a schematic illustration of an artificial neuron with 4 input values 4 weights and an activation function.

FIG. 12 is a schematic illustration of feedforward fully connected network with four input neurons and two hidden layers, each containing five neurons.

FIGS. 13A and 13B are schematic illustrations of an RNN (FIG. 13A) and a bidirectional RNN (FIG. 13B).

FIG. 14 is a flowchart diagram of a method suitable for comparing sequences, according to various exemplary embodiments of the present invention.

FIG. 15 is a schematic illustration describing a method suitable for comparing sequences, according to various exemplary embodiments of the present invention.

FIG. 16 is a schematic illustration of a computer system that can be used for comparing sequences.

FIGS. 17A-D illustrate various alignment networks, used in additional experiments performed according to some embodiments of the present invention.

### DESCRIPTION OF SPECIFIC EMBODIMENTS OF THE INVENTION

The present invention, in some embodiments thereof, relates to sequence analysis and, more particularly, but not exclusively, to a method and system for comparing sequences, such as, but not limited to, computer codes.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

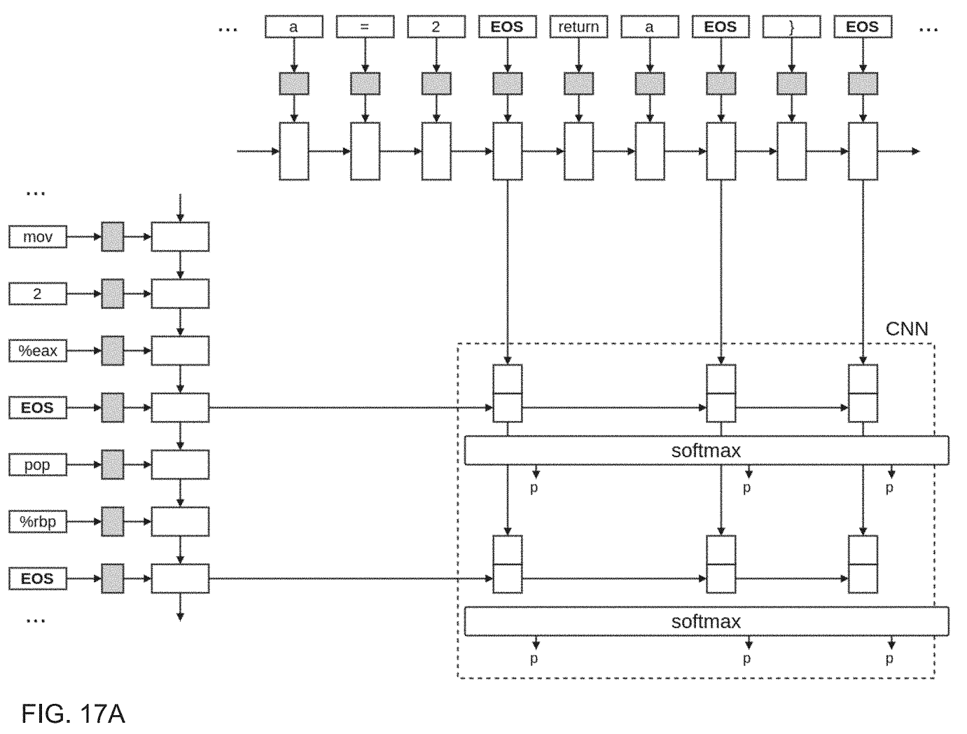

FIG. 14 is a flowchart diagram of a method suitable for comparing sequences, according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

At least part of the operations described herein can be can be implemented by a data processing system, e.g., a dedicated circuitry or a general purpose computer, configured for receiving data and executing the operations described below. At least part of the operations can be implemented by a cloud-computing facility at a remote location.

Computer programs implementing the method of the present embodiments can commonly be distributed to users by a communication network or on a distribution medium such as, but not limited to, a floppy disk, a CD-ROM, a flash memory device and a portable hard drive. From the communication network or distribution medium, the computer programs can be copied to a hard disk or a similar intermediate storage medium. The computer programs can be run by loading the code instructions either from their distribution medium or their intermediate storage medium into the execution memory of the computer, configuring the computer to act in accordance with the method of this invention. All these operations are well-known to those skilled in the art of computer systems.

Processing operations described herein may be performed by means of processer circuit, such as a DSP, microcontroller, FPGA, ASIC, etc., or any other conventional and/or dedicated computing system.

The method of the present embodiments can be embodied in many forms. For example, it can be embodied in on a tangible medium such as a computer for performing the method operations. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

Referring now to FIG. 14, the method begins at 10 and optionally and preferably continues to 11 at which two or more sets of sequences are obtained as input. The sets can be received from a user interface device, streamed over a direct communication line, or downloaded over a communication network (e.g., the internet, or a private network, such as, but not limited to, a virtual private network). The present embodiments are useful for many types of sequences received as input. In some embodiments of the present invention one or two or more of the sets of sequences is a computer code. In these embodiments, each sequence of a set that forms a computer code preferably represents an instruction statement of the computer code, one sequence for each instruction statement.

For example, one set of sequences can be a programming language source code, e.g., a high-level programming language source code, and another set of sequences can be an object code.

As used herein, “high-level programming language” refers to a programming language that may be compiled into an assembly language or object code for processors having different architectures. As an example, C is a high-level language because a program written in C may be compiled into assembly language for many different processor architectures.

As used herein, “object code” oftentimes referred to as “machine language code” refers to a symbolic language with a mnemonic or a symbolic name representing an operation code (also referred to as an opcode) of the instruction and optionally also an operand (e.g., data location). An object code is specific to a particular computer architecture, unlike high-level programming languages, which may be compiled into different assembly languages for a number of computer architectures. A machine language is oftentimes referred to as a low-level programming language. A representative example of a machine language is as assembly language.

Typically, but not necessarily, high-level languages generally have a higher level of abstraction relative to machine languages. For example, a high level programming language may hide aspects of operation of the described system such as memory management or machine instructions.

When one set of sequences is a programming language source code, e.g., a high-level programming language source code, and another set of sequences is an object code, the object code is optionally and preferably generated by compiler software applied to the programming language source code. These embodiments are particularly useful when the method is executed to determine whether all the instruction statements of the machine code actually originate from instruction statements in the source code, and/or to assess the accuracy of the compilation process applied by the compiler. Alternatively, the object code is generated by compiler software applied to another programming language source code which includes at least a portion of the input programming language source code and at least one sub-code not present in the input programming language source code. These embodiments are particularly useful when the method is executed to identifies the potentially malicious sub-codes in the object code.

In some embodiments of the present invention, two of the sets of sequences are programming language source codes, e.g., a high-level programming language source codes. Preferably, one of the programming language source codes is generated by a computer code translation software applied to the other programming language source code. These embodiments are particularly useful when the method is executed to assess the accuracy of the translation between the languages.

In some embodiments of the present invention, two of the sets of sequences are object codes. Preferably, the two object codes are generated by different compilation processes applied to the same programming language source code. The different compilation processes may be executed by different compiler software or by the same compiler software but using different compilation parameters, and/or using different target architectures. These embodiments are particularly useful when the method is executed to assess the accuracy of one compilation process in comparison to another compilation process.

In some embodiments of the present invention one or two of the sets of sequences is a binary machine code, such as, but not limited to, a binary code which is translated by an assembler from an object code and which is therefore equivalent to the object code. A binary machine code is typically a series of ones and zeros providing machine-readable instructions to the processor to carry out the instructions in the equivalent object code.

In some embodiments of the present invention two of the sets of sequences are binary machine codes, in some embodiments of the present invention one of the sets of sequences is a binary machine code and another one of the sets of sequences is an object code, and in some embodiments of the present invention one of the sets of sequences is a binary machine code and another one of the sets of sequences is a programming language source code, e.g., a high-level programming language source code. Embodiments in which one or more of the sets of sequences is a binary machine code are useful, for example, for assessing the performance of an assembler, for comparing performances of two assemblers, or the like.

Other types of codes, such as, but not limited to, hardware description language codes, hardware verification language codes and property specification language codes, are also contemplated as input 11. Further contemplated are other types of sequences, such as, but not limited to, text corpuses, amino-acid sequences, sequences describing patterns or graphs or the like.

Each of the sequences of each input set comprises one or more tokens selected from a vocabulary of tokes that is characteristic to the set. For example, when a set is a computer code of a particular language, the vocabulary includes all the reserved words of the particular language and optionally and preferably also single-character elements that are interpreted by the computer as operands or variables. Consider, for example, an instruction statement “if (a5<4);” which is an acceptable syntax in C. This statement forms a sequence of 8 tokens, wherein the first token is the reserved word “if”, the second token is the single-character “(”, the third token is the single-character “a”, the fourth token is the single-character “5”, the fifth token is the single-character “<”, the sixth token is the single-character “4”, the seventh token is the single-character “)” and the eighth token is the single-character “;”.

In some embodiments of the present invention the method redefines one or two or more of the set of sequences such that each sequence of each set includes a single terminal token in addition to the other token. For example, the method can introduce a sequence-end token at the end of each sequence or a sequence-start token at the beginning of each sequence. For example, when a set of sequences is a code (e.g., a computer code) in which each sequence represents an instruction statement, an end-of-statement (EOS) token can be added at the end of each sequence. Thus, in the above example for the instruction statement “if (a5<4);” the aforementioned 8 token sequence becomes a 9 token sequence in which the EOS token is in its ninth position.

The method preferably continues to 12 at which each sequence is converted to a sequence of binary vectors. The binary vectors can be according to any scheme, such as, but not limited to, a base 2 scheme, a gray code scheme, a one-hot scheme, a zero-hot scheme and the like. The dimensionality of each vector is optionally and preferably the same as the number of vocabulary-elements of the respective vocabulary. For example, consider, for simplicity, a one-hot scheme for the binary vectors, and a vocabulary that include only the following vocabulary-elements: “word1”, “word2”, “X” and “=”. In this simplified example, 4-dimensional binary vectors can be used, wherein, for example, “word1” is converted to (1,0,0,0), “word2” is converted to (0,1,0,0), “X” is converted to (0,0,1,0) and “=” is converted to (0,0,0,1). In the preferred embodiment in which the sequences are redefined to include also a terminal token (e.g., the EOS token), the dimensionality increases by one, so that, e.g., “word1” is converted to (1,0,0,0,0), “word2” is converted to (0,1,0,0,0), “X” is converted to (0,0,1,0,0), “=” is converted to (0,0,0,1,0) and “EOS” is converted to (0,0,0,0,1). In various exemplary embodiments of the invention each sequence of binary vectors (which corresponds to an input sequence, itself being an element of the input set of sequences) is concatenated, so as to describe each input sequence as a single vector.

It is appreciated that a typical vocabulary may include much more than four vocabulary-elements, e.g., tens of vocabulary-elements (for example, for a programming language source code the vocabulary can include the entire English alphabet, several punctuation marks, and all the reserved words of that language), so that the above simplified example is not to be considered as limiting.

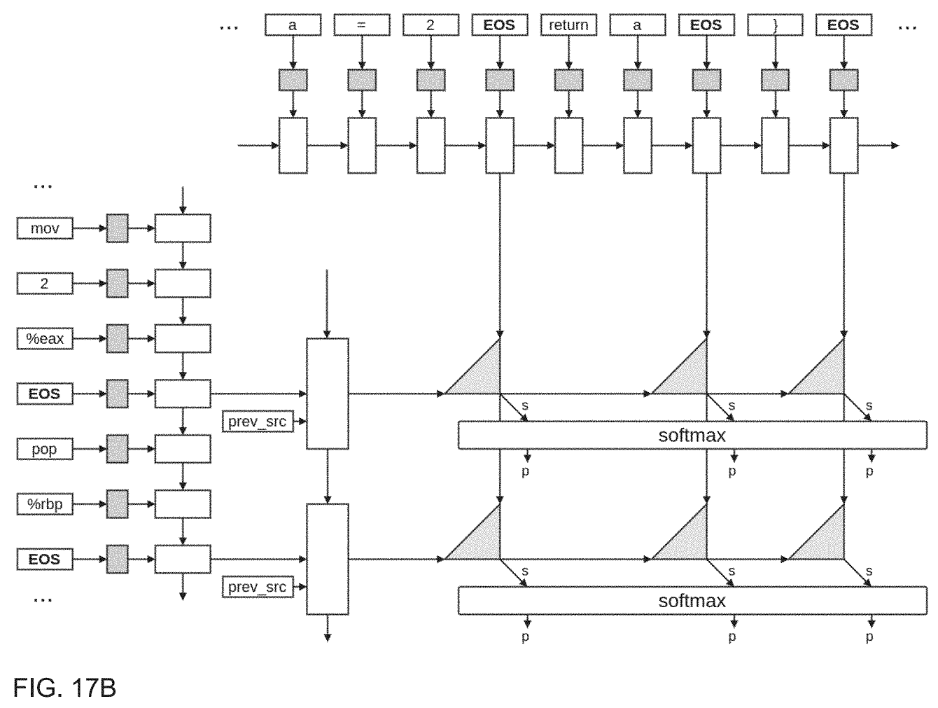

The method optionally and preferably continues to 13 at which an encoder is applied to each set so as to encode the set into a collection of vectors, each vector representing one sequence of the set. The procedure is illustrated schematically in FIG. 15. Shown are a first set 30 of M sequences, denoted Seq. 1, Seq. 2, . . . , Seq. M, and a second set 32 of N sequences, denoted Seq. 1, Seq. 2, . . . , Seq. N. The sequences of set 30 are fed into an encoder 34 which produces a collection 42 of M vectors denoted v₁, v₂, . . . v_{M}, respectively corresponding to the M sequences of set 30. The sequences of set 32 are fed into an encoder 36 which produces a collection 44 of N vectors denoted u₁, u₂, . . . u_{N}, respectively corresponding to the N sequences of set 32. When the sets are defined over different vocabularies, encoders 34 and 36 are different from each other. When the sets are defined over identical vocabularies, encoders 34 and 36 can be the same. In some embodiments of the present invention, all the vectors produced by encoders 34 and 36 are of the same length, this need not necessarily be the case, since, for some applications, it may be desired to construct encoders that produce vectors of various lengths.

In the preferred embodiment in which the sequences are converted to binary vectors, the binary vectors are fed to the encoders. In the preferred embodiment in which the binary vectors corresponding to each sequence are concatenated, the results of this concatenation are fed to the encoder. Specifically, for each sequence, the encoder is fed by a binary vector that is the concatenation of all the binary vectors into which the sequence has been converted. Since there are two or more sets, the encoder encodes two or more collections of vectors, one collection for each set.

The encoder preferably employs a trained neural network, more preferably a Recurrent Neural Network (RNN), even more preferably a bi-directional RNN. In some embodiments of the present invention, the encoder employs a long short-term memory (LSTM) network. A primer on neural networks is provided in Annex 1, below.

The encoder is applied to the sets separately. The encoder processes each of the sequences of the set, preferably separately, and finds relations among the sequences, such as, but not limited to, sequences that forms blocks with the set. For example, when the sequences are computer codes, the encoder finds instruction blocks, e.g., loops, if blocks, procedures, and the like. The similarity between vectors produced by the encoder for different sequences (e.g., different instruction statements) reflect the relations between the respective sequences. Typically, but not necessarily, the similarity between the vectors can be quantified by their scalar product, but other types of similarity measures in other metric spaces are also contemplated. Suppose, for simplicity, that two statements the output of encoder are related to each other (e.g., one opens a loop and the other closes a loop, or the two are within the same function or loop), in this case there is a high similarity level between the vectors that are produced by the encoder in response to the sequences that represent these two statements (e.g., the scalar product between the produced vectors has a high value). It is to be understood, however, that there is no need to determine the similarity between the vectors produced by the encoder, since these vectors are optionally and preferably fed to another neural network as further detailed hereinbelow.

It was found by the inventor that it is advantageous to use a LSTM network as the encoder since such a network, once trained, can capture long duration and complex dependencies among sequence elements.

When the encoder employs a neural network (preferably RNN, more preferably bi-directional RNN, even more preferably LSTM) the output of the encoder is a collection of vectors wherein each vector is indicatives of neural activation values of one or more tokens of the respective sequence at the output layer of the neural network. In various exemplary embodiments of the invention the encoder provides, for each sequence, a single vector corresponding to a single representative token within the sequence. This allows the encoder to learn representations that correspond to sequences of tokens (each sequences that respectively correspond to statements), unlike conventional recurrent neural networks that produce a vector for each element of the sequence and that therefore learn representations that correspond to tokens in the input sequences. In embodiments in which the terminal token is introduced, the representative token is optionally and preferably the terminal token.

In these embodiments, the vector produced by the encoder is indicative of the neural activation values of the single representative token of the respective sequence. For example, when the method introduces a sequence-end token at the end of each sequence (e.g., an EOS token for computer codes) the vector produced by the encoder is indicative of the neural activation values of the sequence-end token. It is noted that the fact that activation values of other tokens are not produced by the encoder does not mean that the other tokens are not processed by the encoder. This is because each activation value is affected by other activation values in the sequence.

The method optionally and preferably continues to 14 at which a grid representation 38 is constructed. With reference to FIG. 15, the grid representation 38 has a plurality of grid-elements 40, each comprising a plurality of vectors, one vector from each of collections produced by the encoder. For example, in the embodiment in which there are two collections 42 and 44 each grid-element 40 comprises a pair (vᵢ;uⱼ) of vectors i=1, . . . , M and j=1, . . . , N, one vector from collection 42 and one vector from collection 44. Since the vectors produced by the encoders are typically multidimensional, the grid representation forms a multichannel grid, one channel for each of the dimensions of the vector. In some embodiments of the present invention the two vectors in the pair are concatenated to each other. In these embodiments the notation (vᵢ;uⱼ) denotes a vector that is the concatenation of vector vᵢ with vector uⱼ.

The method can then continue to 15 at which the grid representation is fed into a trained convolutional neural network (CNN) 46. The CNN 46 is optionally and preferably a multichannel CNN constructed to simultaneously process all the grid-elements 40 of grid representation 38. The CNN 46 preferably comprises a plurality of subnetworks, each being fed by one of grid elements 40. In some embodiments of the present invention at least a portion of the subnetworks, e.g., all the subnetworks, are replicas of each other. In some embodiments of the present invention the subnetworks include the same number and type of layers, and/or the same activation functions, and/or the same number and size of filters. The use of subnetworks is advantageous since it makes the processing of all the grid-elements more simultaneous.

The output of CNN 46 is optionally and preferably used for generating 16 a grid output 48 having a plurality of grid-elements 50. In various exemplary embodiments of the invention each of grid elements 50 defines a similarity level between vectors in one grid-element 40 of grid representation 38. Thus, grid output 48 can include a grid element 50 that defines a similarity level sᵢⱼ between vector vᵢ of collection 42 and vector uⱼ of collection 44 and that is indicative of the similarity between the input sequences that were encoded into these vectors (Seq. i of set 30, and Seq. j of set 32). The similarity level sᵢⱼ can be provided as a matching score defined over a predetermined scale (e.g., between 0 for no match and 100 for full match), or it can be provided as a probability indicative of the likelihood that the two sequences correspond to each other (e.g., one sequence is a compiled version of the other sequence), or it can be provided as a pseudo probability indicative of a correlation between the two sequences.

The method ends at 17.

Grid output 48 can provide a mapping between sequences of different sets, for example, a mapping from the ith sequence of set 30 to the jth sequence of set 32. In these embodiments, the similarity level sᵢⱼ is optionally and preferably binary indicative of either a match or a no-match between the respective sequences. The mapping can be a one-to-one mapping, but is typically not a one-to-one mapping, particularly when the sets correspond to different languages. For example, when one set is an object code and the other set is a programming language source code, the comparison can optionally and preferably provide a “many-to-one” mapping from object code statements to programming language source code statements. This is because some compilers perform optimization procedure so that while every object code statement corresponds to some programming language source code statement, not all programming language source code statements are covered.

It is appreciated that hardware can be trusted when there is a full functional identity between the designer source, the object resulting from the manufacturer compilation, and the actual silicon implementation. Detection of hardware Trojans is optionally and preferably based on authenticating two or more transfers, preferably every transfer, along the manufacturing process. The method of the present embodiments can be applied for comparing the results of all these transformations since regardless of the logical form of the function, under the assumption of mapping one statement structure to another such that every statement in the second set of sequences stems from a single statement in the first set of sequences, the matching can be detected.

The grid output 48 of the present embodiments can therefore be used in more than one way. In some embodiments, the grid output is used for determining malicious modification of a source code during compilation, for example, at the foundry. Thus, according to some embodiments of the present invention the method generates an output pertaining to potentially malicious computer code statements that are present in a computer code forming one of the sets, but not in a computer code forming the other set. In some embodiments of the present invention the method identifies a sub-code formed by these potentially malicious computer code statements, and generates an output identifying the sub-code as malicious. The identification of sub-codes can be, for example, by acceding a computer readable library of malicious sub-codes and comparing the sub-codes in the library to the sub-code that is formed by the potentially malicious computer code statements.

In some embodiments of the present invention a machine code is compared with a recompiled machine code, in which case the grid output 48 can be used for analyzing executable computer codes as these shift from one version to the next, and the analysis of electronic devices as models are being replaced. The grid output 48 of the present embodiments can be used for other applications, including, without limitations, static code analysis, compiler verification and program debugging. The present embodiments can be used for matching two machine codes that represent the same program but were compiled differently (e.g., by different compilers, using different compilation flags, using different target architecture, etc.). The grid output 48 of the present embodiments can be used for comparing between two un-compiled source codes, e.g., codes written in different programming languages. This is particularly useful when one of the codes is a translation of the other, in which case the grid output 48 of the present embodiments can used for determining the accuracy of the translation. The grid output 48 of the present embodiments can also be used for inspecting the dynamic behavior of a system and compare it with its static code.

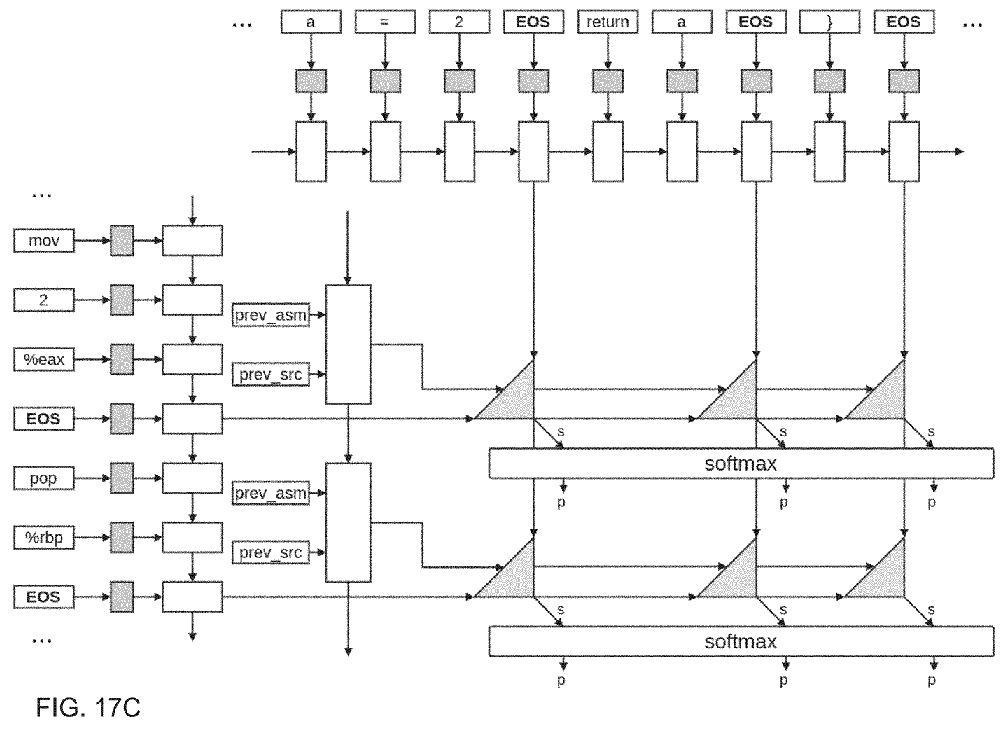

FIG. 16 is a schematic illustration of a client computer 130 having a hardware processor 132, which typically comprises an input/output (I/O) circuit 134, a hardware central processing unit (CPU) 136 (e.g., a hardware microprocessor), and a hardware memory 138 which typically includes both volatile memory and non-volatile memory. CPU 136 is in communication with I/O circuit 134 and memory 138. Client computer 130 preferably comprises a graphical user interface (GUI) 142 in communication with processor 132. I/O circuit 134 preferably communicates information in appropriately structured form to and from GUI 142. Also shown is a server computer 150 which can similarly include a hardware processor 152, an I/O circuit 154, a hardware CPU 156, a hardware memory 158. I/O circuits 134 and 154 of client 130 and server 150 computers can operate as transceivers that communicate information with each other via a wired or wireless communication. For example, client 130 and server 150 computers can communicate via a network 140, such as a local area network (LAN), a wide area network (WAN) or the Internet. Server computer 150 can be in some embodiments be a part of a cloud computing resource of a cloud computing facility in communication with client computer 130 over the network 140.

GUI 142 and processor 132 can be integrated together within the same housing or they can be separate units communicating with each other. GUI 142 can optionally and preferably be part of a system including a dedicated CPU and I/O circuits (not shown) to allow GUI 142 to communicate with processor 132. Processor 132 issues to GUI 142 graphical and textual output generated by CPU 136. Processor 132 also receives from GUI 142 signals pertaining to control commands generated by GUI 142 in response to user input. GUI 142 can be of any type known in the art, such as, but not limited to, a keyboard and a display, a touch screen, and the like. In some embodiments, GUI 142 is a GUI of a mobile device such as a smartphone, a tablet, a smartwatch and the like. When GUI 142 is a GUI of a mobile device, processor 132, the CPU circuit of the mobile device can serve as processor 132 and can execute the code instructions described herein.

Client 130 and server 150 computers can further comprise one or more computer-readable storage media 144, 164, respectively. Media 144 and 164 are preferably non-transitory storage media storing computer code instructions as further detailed herein, and processors 132 and 152 execute these code instructions. The code instructions can be run by loading the respective code instructions into the respective execution memories 138 and 158 of the respective processors 132 and 152. Storage media 164 preferably also store a library of reference data as further detailed hereinabove.

Each of storage media 144 and 164 can store program instructions which, when read by the respective processor, cause the processor to input sets of sequences and execute the method described herein. In some embodiments of the present invention, the sets of sequences are input to processor 132 by means of I/O circuit 134. Processor 132 can process the sets of sequences as further detailed hereinabove and display the grid output, for example, on GUI 142. Alternatively, processor 132 can transmit the sets of sequences image over network 140 to server computer 150. Computer 150 receives sets of sequences, process the sets of sequences as further detailed hereinabove and transmits the grid output back to computer 130 over network 140. Computer 130 receives the grid output and displays it on GUI 142.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

The present example addresses the task of statement-by-statement alignment of source code and the compiled object code. The present Inventors employ a deep neural network, which maps each statement to a context-dependent representation vector and then compares such vectors across the two code domains: source and object.

As an immediate application for real-world cybersecurity threats, the present Inventors demonstrate that superfluous statements in the object code that do not match any statement of the source code can be detected. Such object code can be maliciously added, for example, in two critical vulnerabilities: (i) the source code is written by one entity, while compilation is done by a second entity, such as is often the case in fabless hardware manufacturing. (ii) the compiler itself is compromised and inserts backdoors to the object code.

Hardware is expected to be the root of trust in most products, and hardware Trojans, once inserted, form a persistent vulnerability. The detection of such Trojans is almost impossible post manufacturing: modern ICs have millions of nodes and billions of possible states, high system complexity, and are of a nano-scale. Besides, it is very difficult to detect unknown threats, for which no signatures exist, especially if they are triggered at a very low probability.

Executable component addition, substitution and reprogramming in the supply chain is therefore a major risk. Unfortunately, inserting malicious code as part of the compilation process done at the foundry is relatively easy and is very hard to prevent. While there are other means for inserting hardware Trojans, none are as cheap and straightforward. Simplified, the relevant steps of the manufacturing process are as follows: (i) The hardware designer writes the source code. (ii) The foundry modifies the code to match manufacturing constraints and in order to support its debugging and other needs. (iii) Compilation takes place at the foundry. (iv) The resulting object code can be made available to the designer. The present Inventors add a new step that would greatly reduce the risk of hardware Trojans: (v) The designer automatically aligns statement-by-statement the original source code with the object code and examines the discrepancies.

The methods of the present embodiments can also be applied to mitigate the risk of compiler backdoors. Since human examiners can much more easily review source code than object code, it is very hard to identify backdoors that are inserted by compromised compilers. By aligning the original source code with the object code, the present embodiments focus the attention of the examiner on suspected object code that was perhaps maliciously added. For a given compiler, the amount of discrepancy between the source code and the compiled code can be statistically inspected. Compilers that present a high level of discrepancy are preferably tagged as compromised.

Statement-by-statement alignment of source- and object-code is not treated in the literature. It might be considered infeasible since the per-statement outcome of the compilation process depends on other statements of the source code. In addition, this outcome is produced in increasing levels of sophistication that are determined by the compiler's optimization flags.

To circumvent the direct modeling of the compiler, the present Inventors employ a compound deep neural network for estimating whether a source code statement matches with an object code statement. The network's architecture combines one Recurrent Neural Network (RNN) per code domain, a grid of replicated similarity computing networks, and multiple softmax layers.

The neural network is trained using a synthetic dataset that was created for this purpose. The dataset contains random C code that is compiled using three levels of optimization. The ground truth alignment labels are extracted from the compiler's output. The extensive experiments presented herein show that the neural network is able to accurately predict the alignment between source code and object code and display uncertainty in alignment in case that the object code is modified. Therefore, as demonstrated, it can be used for identifying the existence of superfluous object code.

In some embodiments the problem of compilation verification is reduced to that of statement by statement alignment. This formulation does not require mimicking the compilation process or trying to invert it, and lends itself to machine learning approaches. In some embodiments, a neural network architecture for addressing this challenging alignment problem is designed. The novel design contains a unique way to encode the inputs, two RNNs that are connected using a grid of similarity computing layers, and top level classification layers.

While neural networks have been used for aligning sequences in the domain of NLP, where a sentence in one natural (human) language is aligned with its translation, the current domain is more challenging. First, each source or object-code statement contains both an operation (reserved C keywords or opcode) and potentially multiple parameters, and are therefore typically more complex than natural language words. Second, highly optimized compilation means that the alignment is highly nonlinear. Lastly, the meaning of each code statement is completely context dependent, since, for example, the variables and registers are used within multiple statements. In natural languages context helps resolve ambiguities, however, a direct dictionary based alignment already provides a moderately accurate result. In the current application, mapping has to depend entirely on context.

Following is a more detailed description of a technique for statement-by-statement alignment according to some embodiments of the invention.

### Code Alignment

Some embodiments of the invention consider computer programs written by an imperative programming language, in which the program's state evolves one statement after the other. In the experiments, the C programming language is used, in which statements are generally separated by a semicolon (;). The compiler transforms the source code to object code, which is a sequence of statements in machine code. For example, the Linux GCC compiler is employed to produce x86 machine code. In order to promote readability, the machine code is viewed as assembly, where each statement contains the opcode and its operands.

If the compilation process is successful the source-code and machine-code represent the same functionality, the object code does not contain unnecessary statements, and one can track the matching source statement to each one of the statements in the object code. During the compilation process, the compiler can retain the object-code to source alignment as it generates the object code in a rule-based manner. GCC and other compilers can append this information to the object file in order, for example, to support debugging using various disassemblers such as GNU's objdump.

By default, however, the alignment information is lost post-compilation. Some embodiments of the invention find the statement level alignment between source code and object code compiled from it.

### Problem Formalization

The statement level alignment between object- and source-code is a many-to-one map from object code statements to source code statements. In some embodiments, the definition of a statement is modified, in order to support the convention implemented within the GCC compiler.

A C statement can be one of the following: (i) a simple statement in C containing one command ending with a semicolon; (ii) curly parentheses ({,}); (iii) the signature of a function; (iv) one of if(EXP1), for(EXP1;EXP2;EXP3), or while(EXP1), including the corresponding expressions; (v) else or do.

Note that the following code

do
{
a += 4;
}
while(i < 500);

contains 5 statements since the “do”, the “{”, the “}”, and the “while” are all separate statements.

The object code statements follow the conventional definition, as shown, for example, in assembly code listings. Each statement contains a single opcode such as “mov”, “jne”, or “pop”, and its operands.

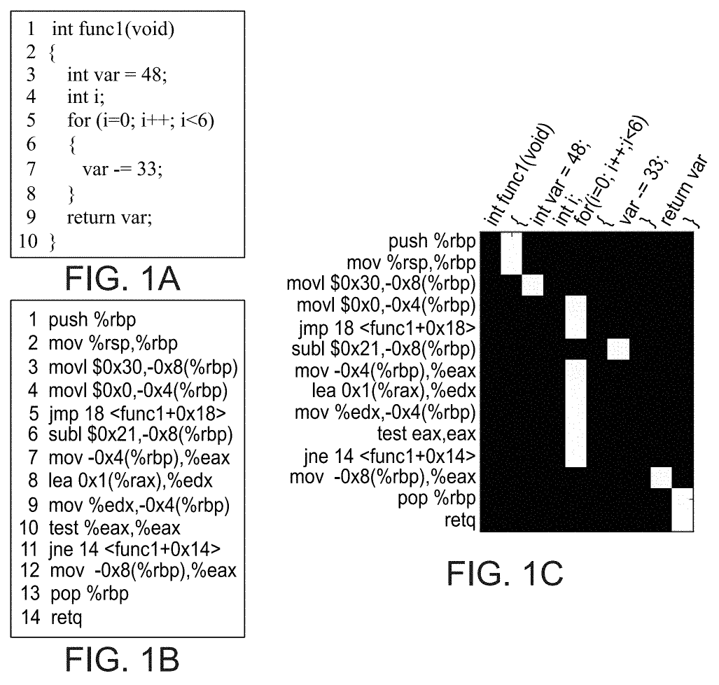

An example is shown in FIGS. 1A and 1B, which depict both the source code of a single C language function, which contains M=10 statements (FIG. 1A), and the compiled object code of this function, which contains N=14 statements (FIG. 1B). The statements are numbered for identification purposes. The alignment between the two is shown graphically in FIG. 1C by using grid output or a matrix output of size N×M. Each row (column) of this matrix corresponds to one object-code (source-code) statement. The matrix (i,j) element encodes the probability of matching object-code statement i=1, . . . , N with the source-code statement j=1, . . . , M. Since the process is deterministic, all probabilities are either 0 (black) or 1 (white). In other words, each row is a “one-hot” vector showing the alignment of one object-code statement i, i.e a vector whose elements are 0 except the single element that corresponds to the identifier of the source-code statement from which statement i resulted.

As can be seen in the figure, the last two opcodes pop and retq correspond to the function's last statement, which is the “} ” that closes the function's block. Also, as expected, there are many opcodes that implement the for statement, which comprises comparing, incrementing, and jumping.

The matrix representation closely matches the target values of the neural network that will be employed for predicting the alignment. This network will output one row of the alignment matrix at a time, as a vector of pseudo-probabilities (positive values that sum to one). The resulting matrix, constructed row by row, can be viewed as a soft-alignment. In order to obtain hard alignments, the probabilities in each row are rounded. The rounding cannot result in more than one value becoming one, unless there is the very unlikely situation in which two probabilities are exactly 0.5. Rounding can lead to an all zero row, which might suggest a superfluous statement in the object code.

It is recognized the object code drastically changes based on the level of compilation optimization used. This optimization makes the object code more efficient and can render it shorter (more common) or longer than the code without optimization.

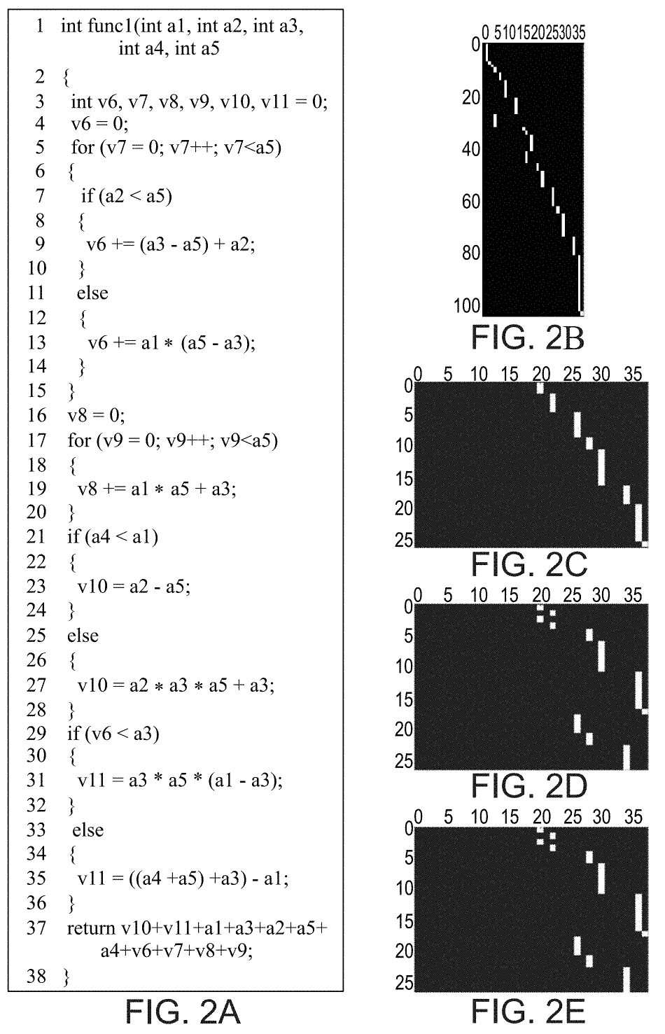

FIGS. 2A-E demonstrates the effect of code optimization. The C code in (A) is being compiled without optimization (B), and with optimization levels 1-3 (C-E). As can be seen, optimization drastically reduces the length of the object code (N) from over a hundred statements in the unoptimized compilation to 26 statements in all three levels of optimization. The optimization also results in parts of the C code that are not covered by any statement of the object code, due to precomputation at compilation time. In general, the alignment is not monotonic, and is less and less so as the level of optimization increases.

As an application to the alignment process, the problem of detecting malicious object code that would not appear in the output of an honest compiler given the source code is considered. Such backdoors, Trojans, and other threats would manifest themselves as object code statements that do not correspond to any of the source statements.

### The Deep Alignment Network

Each statement is encoded as a sequence of binary vectors that captures both the type of the statement, e.g., the opcode of the object code statement, and the operands. The last vector of each such sequence is always the end-of-statement (EOS) vector. A function is given by concatenating all such sequences to one sequence, in the order of the statements.

A compound deep neural network is employed for predicting the alignment, as explained above. It consists of four parts: the first part is used for representing each source-code statement j as a vector vⱼ. The second part does the same for the object code, resulting in representation vectors uᵢ. The third part processes a pair of vector representations, one of each type, and produces a matching score s(uᵢ,vⱼ). This matching score is not a probability. However, the higher the matching value, the more likely the two statements are to correspond. The third part is replicated across all (i,j) pairs and the scores are fed to the top-most part of the network, which computes the pseudo probabilities pᵢⱼ of matching object code statement i with the source code statement j. Specifically, the forth part considers for an object-code statement i all possible source-code matches j=1, 2, . . . , M the matching score, and employs the softmax function:

pᵢⱼ=exp(s(uᵢ,vⱼ))/Σₖ₌₁^{M} exp(s(uᵢ,vₖ))

### Encoding the Input Statements

Most neural networks accept vectors as inputs. Recurrent Neural Networks (RNNs) accept sequences of varying lengths of vectors. In the compound network architecture of the present embodiments, two recurrent neural networks are incorporated in order to encode the statements. Therefore, the statements are first converted to a sequence of vectors. This is done by converting each program statement to a sequence of high dimensional binary vectors (one statement to many vectors). A different binary vector embeddings is used for source code and for object code, as each is composed of a different vocabulary. The encoding is dictionary based and is a hybrid in the sense that some binary vectors correspond to tokens and some to single characters.

The object code vocabulary is a hybrid of opcodes and the characters of the following operands and is based on the assembly representation of the machine code. The opcode of each statement is one out of dozens of possible values. The operands are either one of the x86 registers or a numeric value that can be either an explicit value, e.g., for assignment, or a memory address reference. In addition, the punctuation marks of the assembly language are encoded. The dictionary therefore contains the following types of elements: (i) the various opcodes; (ii) the identifiers of the registers; (iii) hexadecimal digits; (iv) the symbols (,),x,-,:; and (v) EOS, which is appended to every statement.

For example, the machine code encoding that corresponds to the following assembly string mov % eax,−0x8(% rbp) is a sequence of ten binary vectors, which ends with the binary vector of EOS. Let ε(α) denote the encoding of a statement part α to a binary vector. The encoding sequence is: ε(mov), ε(% eax), ε(−), ε(0), ε(x), ε(8), ε(( ), ε(% rbp), ε( ) ), ε(EOS).

The encoding function ε employs one-hot encoding: each vocabulary word α is associated with a single vector element. This element is one in ε(α) and zero in all other cases.

Similarly, the source code vocabulary is also a hybrid of characters and tokens. A C command is mapped to a single binary vector, while variable names and arguments are decomposed to a character by character sequences. The dictionary contains the C language reserved words as atomic units, EOS, and the following single character elements: (i) space (b) alphanumeric characters including all letters and digits; (c) the mathematical operators +, −, *; and (d) the following punctuation marks: (,), {,}, <, >, =, ,, ;. Let ε′β) denote the one-hot encoding of a C statement part β to a binary vector. The C code string if (a5<42), for example, is decomposed to the following sequence of ten binary vectors: ε′(if), ε′(˜˜),ε′(( ),ε′(a), ε′(5), ε′(<),ε′(4), ε′(2), ε′( ) ),ε′(EOS).

### Neural Network Architecture

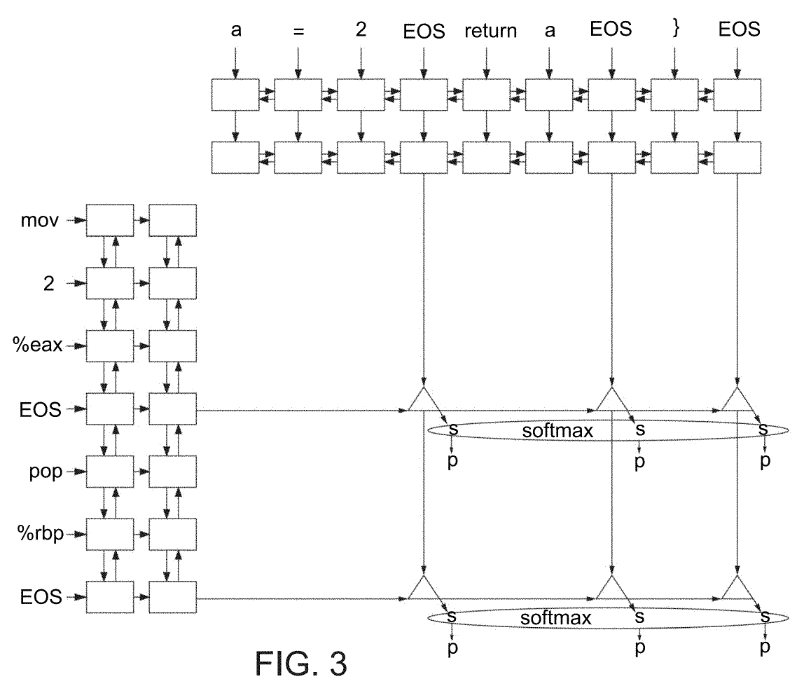

The network architecture used in the experiments of this Example is depicted in FIG. 3. The source- and object-code both introduce many complex and long-range dependencies. Therefore, the network employs, among other components, two RNN subcomponents: one BiLSTM network is used for creating a representation of the source code statements and one is used for representing the object code. Each BiLSTM contains two layers, each with 50 LSTM cells in each direction: forward and backward.

Recall that each statement is broken down into a sequence of binary vectors. RNNs compute a separate set of activations for each element in the input sequence. However, for alignment, a feed-forward fully connected network is employed so that a single vector representation per statement is sufficient. This is solved by representing the entire statement by the activations produced by the final binary vector, which corresponds to EOS. The information in the other binary vectors is not lost since the RNNs are laterally connected, and each activation is affected by other activations in the sequence. Moreover, since EOS is ubiquitous, its representation is preferably based on its context, otherwise it is meaningless. During training, the network learns to create meaningful representations at the sequence location of the EOS inputs.

A fully connected network s is attached to each one of the NM pairs of object-code EOS activations (uᵢ) and source-code EOS activations (vⱼ). The same network weights are replicated between all NM occurrences and are trained jointly. The present Inventors call this replicated network a similarity computing network since it is trained to output high values s(uᵢ,vⱼ) for matching pairs of source- and object-code statements. The input size of s is 2×2×50=200 (two code domains, two directions, and 50 LSTM cells in each direction) and a single hidden layer of size 200, which is connected to the single output that constitutes the similarity score. Sigmoid activation units are used as the network's nonlinear function.

In the one-to-many alignment problem, the network's output for each row optionally and preferably contains pseudo probabilities. A softmax layer was therefore added on top of the list of similarity values computed for each object-code statement i: s(uᵢ,v₁), s(uᵢ,v₂), . . . , s(uᵢ,v_{M}), i.e., there are N softmax layers, each converting M similarity scores to a vector of probabilities.

During training, the Negative Log Likelihood loss is used. Let A be the set of N object-code to source-code matches (i,j). The training loss for a single training example is given by

Σ_{(i,j)∈A}−log(pᵢⱼ).

This loss is minimized when, for all pairs (i,j) of ground truth matches, pᵢⱼ=1.

### Measuring the Alignment Quality

One motivating application is to decide whether a Trojan was inserted to the object code by observing the predicted alignment of the trusted source code with the object code. The predicted alignment can present more uncertainty when superfluous code is inserted. The vector of pseudo-probabilities [pᵢ₁pᵢ₂, . . . , p_{iM}] for a superfluous object code statement i is typically not to be all equally low since by its nature the softmax function emphasizes the highest input score.

Intuitive quality scores are used to measure the certainty of the predicted alignment matrix and obtain one global score per each alignment matrix P=[pᵢⱼ]. When these scores are low, the observed object code can be more likely to be tampered. Four alternative quality scores are considered. The first three quality scores examine the highest probability obtained for each machine code statement.

Let J be the function that computes the index of the highest probability match to each object code statement i, i.e., J(P,i)=argmaxⱼ pᵢⱼ. The vector q given by qᵢ=p_{i,J(P,i)} is considered.

The first quality score is the minimal value of q. This value represents the maximal alignment pseudo-probability of the least certain object-code statement. The second quality score is the mean value of this vector Σᵢ qᵢ/N. This quality score has the advantage of not relying on a single value, however, the signal generated from low matching probabilities can dilute when the function's object code is lengthy. Therefore, a third quality score that is the mean of the three smallest values in q is used. This measure combines the advantages of both the first and the second quality scores.

The forth quality score examines the norm of each row of the matrix P. When there is no uncertainty the norm is one. With added uncertainty, since the sum of pseudo probabilities is fixed, this norm drops. To obtain one measure to the entire matrix P the average of these norms is examined: Σᵢ∥[pᵢ₁,pᵢ₂, . . . , p_{iM}]∥₂/N.

As can be seen in the experiments presented herein, the four quality scores perform similarly for Trojan detection, with the third and forth quality score showing slight advantage. Other quality scores, such as the mean entropy across the object code statements can also be used.

Application of machine learning was deliberately avoided in order to learn a discriminative quality score, e.g., by collecting a training set of source-code together with matching examples of object-code that are either intact or modified and training, for example, an RNN over the vector q (viewed as a sequence) to predict this binary label. The reason is that it is desired the quality score to be human interpretable and to avoid overfitting on the training set that would be used for learning the quality score. By relying on simple scores, the generality of the method is ensured.

### Training the Network

In order to train and test the neural alignment model of the present embodiments, the present Inventors used data set of artificial C functions generated randomly. In order to generate random C code, the present Inventors modified a publicly available open-source random program generator for python distributed by the GitHub repository under the name pyfuzz. In addition to modifying pyfuzz so it will output programs written in C rather than python, the present Inventors also degenerated it so that the code it outputs would consist of one function with the following characteristics: receives 5 integer arguments; returns an integer result which is the sum of all arguments and local variables; consists of local integer variable declarations, mathematical operations (addition, subtraction and multiplication), for loops, if-else statements, and if-else statements nested in for loops.

The reason for the relatively large number of arguments and for returning the sum of all arguments and variables, is the need to avoid code reduction due to compiler optimization. When compiler optimization is activated, the resulting binary might be a very reduced version of the source code, especially for random code of mathematical computations. One reason is that the compiler does not output operations that are related to variables that have no effect on the returned value. Returning the sum of all variables and arguments causes each one of them to affect the returned result. Another reason for code reduction is precomputation of values known during compilation time, e.g., the final value of a counter that is incremented a predetermined number of times. Having a large number of arguments also helps in that manner: argument values are unknown during compilation time so the compiler cannot precompute source code operations involving them. This results in long and complex binaries.

### Compilation

In order to compile the generated source code with optimizations, the GCC compiler was used with three of its -O optimization levels, invoked by supplying it with the arguments -O1, -O2 or -O3. Each optimization level turns on many optimization flags. With -O1, GCC tries to reduce code size and execution time without investing too much compilation time. With -O2, GCC turns on all flags of -O1 level and additionally performs optimizations that do not involve a space-speed trade-off. This level increases the binary performance. With -O3, GCC turns on all -O2 flags and ten more flags that address relatively rare cases.

The data set of generated C functions has three parts. Each part is compiled using one of the three mentioned optimization levels. In addition, GCC provided output debugging information that includes the statement level alignment between each function written in C and the object code compiled from it. The resulting data set consists of samples of source code, object code compiled at some optimization level, and the statement-by-statement alignment between them. In order to conduct experiments, the whole data set is randomly divided to training, validation and test sets, where the latter is used exclusively for computing performance statistics of the final system.

### Training Parameters

The present Inventors trained one network for all optimization levels. This corresponds to a situation in which the optimization level used is not known and therefore a specialized network is difficult to employ. 135,000 training samples are used, each containing one source function of varying length and the compiled code. These are divided to 4,500 batches of 30 samples each. The validation and the test sets each contain 7,500 samples.

The weights of the neural networks are initialized uniformly in [−1.0,1.0]. The biases of the BiLSTM networks and the fully connected network are initialized to 0, except for the biases of the LSTM forget gates, which are initialized to 1 in order to encourage memorization at the beginning of training. The network is trained for 10 epochs. The Adam learning rate scheme is used, with a learning rate of 0.001, β₁=0.9, β₂=0.999, and ε=1E-08.

### Evaluation

The present Inventors perform multiple levels of validation to the method of the present embodiments using the dataset described above. First, the accuracy of the alignment was evaluated. Second, a few interesting cases were qualitatively studied. Third, the capability of the network to detect superfluous code, which simulates backdoors, was evaluated.

### Alignment

Table 1, below, shows the accuracy of the alignment process. The accuracy is computed per object-code statement and not per function and is computed as follows: First, the network predicts pseudo-probabilities of matching source code statement to each object code statement. Second, in order to obtain hard alignments, the soft alignments were rounded. This would result in no more than one matching statement. Third, for every object code statement, a true identification was counted only if there is a matching and the matched source statement is the ground truth matching. The accuracy is reported for the three levels of optimization and for the combined dataset.

TABLE 1

| Optimization level | Accuracy |
|---|---|
| -O1 | 99.08% |
| -O2 | 96.77% |
| -O3 | 97.10% |
| All combined | 97.61% |

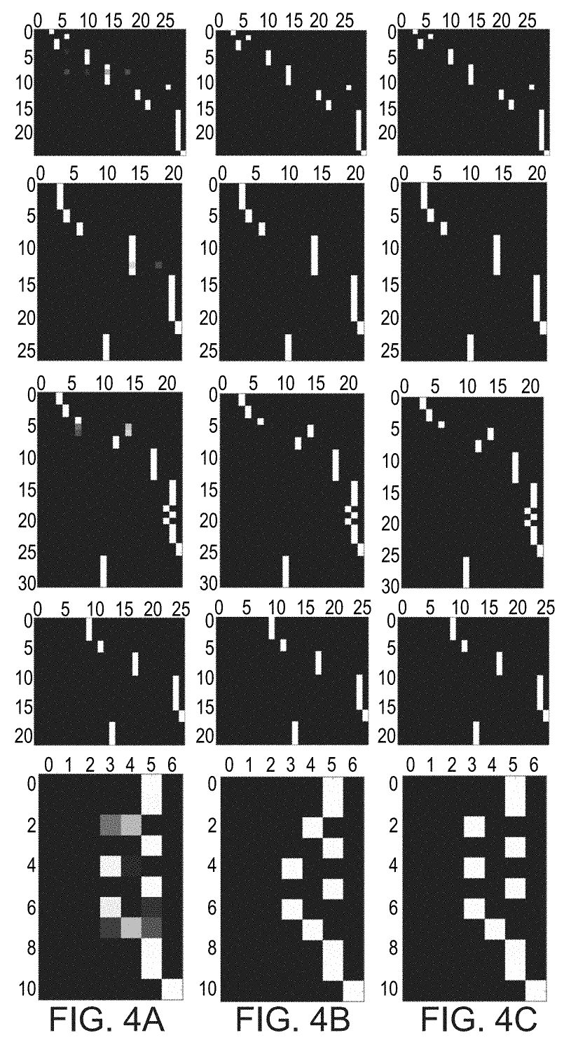

A few results are shown in FIGS. 4A-C, where the soft- and the hard-predictions are displayed side by side with the ground truth. It is evident that the soft predictions themselves are mostly confident with values that are concentrated around 0 and 1, and that the hard-predictions closely match the ground truth alignments.

### Qualitative Evaluation

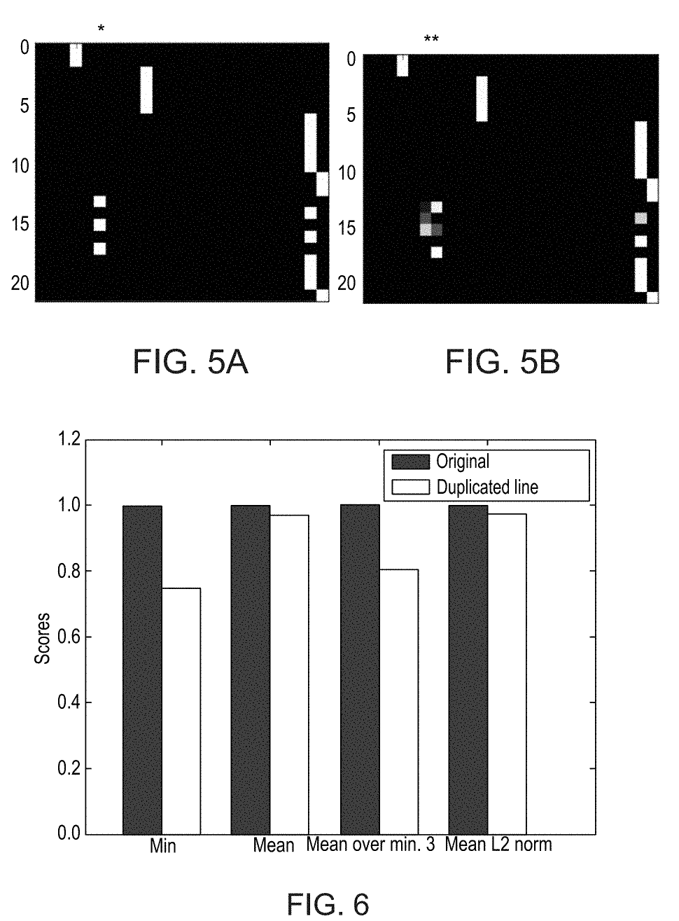

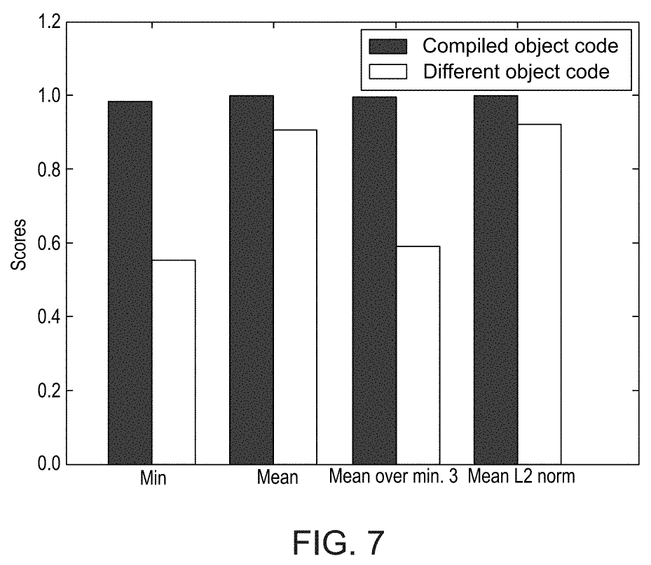

In order to better understand the behavior of the alignment system, the present Inventors performed two different toy experiments. In the first experiment, a C source code was compiled and a second version of it where one random statement is duplicated was created. Both the original C code and the modified one were aligned with the result of the compilation. The network alignment predictions are shown in FIGS. 5A-B. As shown, the alignment of the two identical statements becomes ambiguous. This ambiguity is detected mostly by the min quality score and the mean of smallest three quality scores, as shown in FIG. 6.

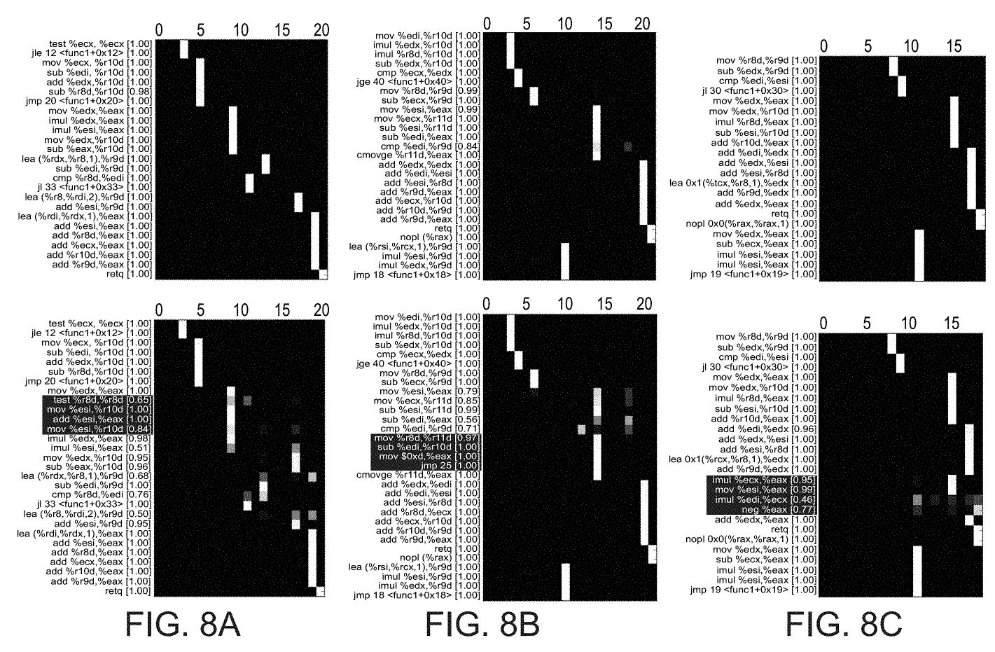

In a second experiment, two functions were created and compiled. Then, the first function was compared to the two object codes using the four quality scores. The experiment was repeated 100 times and the mean results are shown in FIG. 7. As can be seen, the same two quality scores are able to identify the correct function.

### Backdoor Detection

In order to simulate the insertion of backdoors to the code, 1-10 random object code statements were inserted to the compiled object code. The inserted code was a continuous sequence of statements sampled from random code that was generated and compiled for this purpose. The point of insertion is selected uniformly.

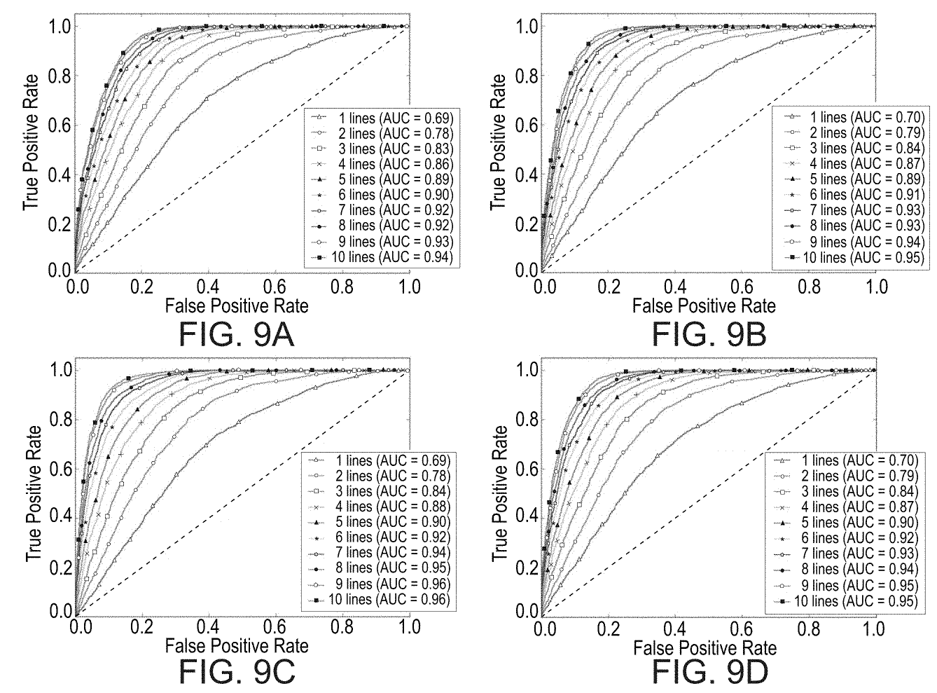

FIGS. 8A-C show examples of the alignment results after such external code insertion. It is clear that such an insertion creates uncertainty in the alignment. While the uncertainty does not always manifest itself at the location of the superfluous code, the effect is still very clear.

In order to evaluate the quality scores that were devised for detecting the insertion of superfluous statements, the Receiver Operating Characteristic (ROC) was employed. This curve displays the trade-off between the false detection rate (x-axis) and the true positive rate (y-axis). To obtain one summary statistics, the Area Under Curve (AUC) is often used. It is the integral of the curve. An AUC of 1 depicts perfect prediction, and an AUC of 0.5 a random one.

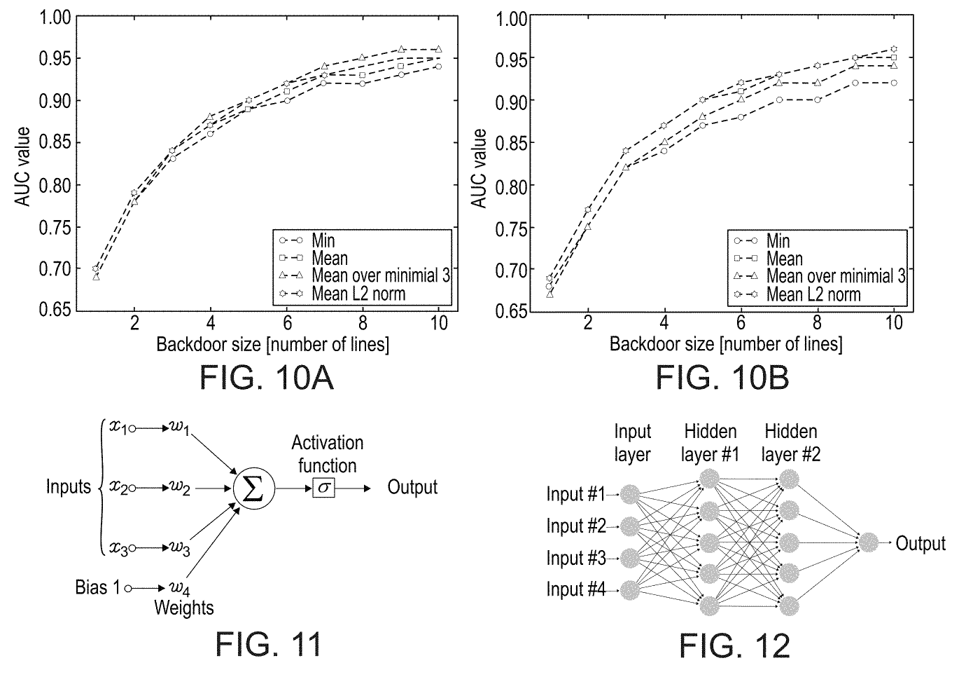

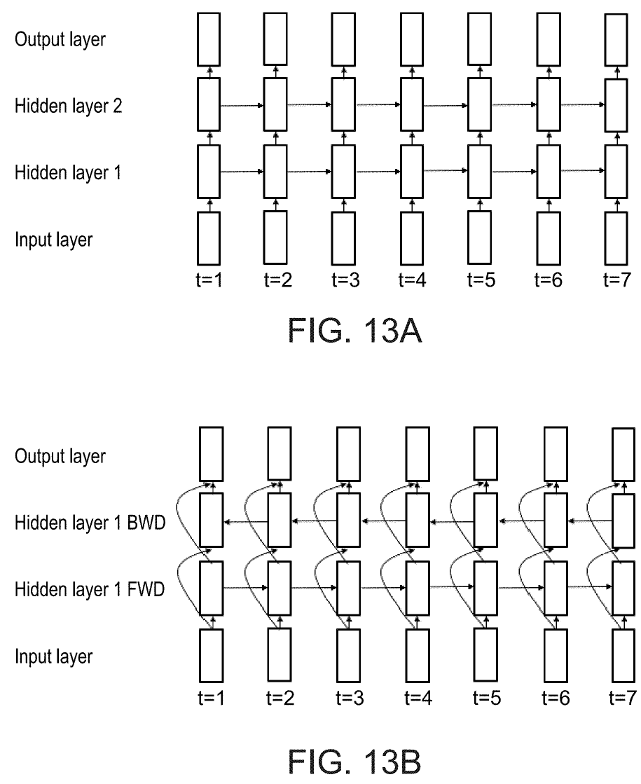

Using the quality score described above, the present Inventors were able to obtain a varying level of success, depending on the length of the planted code. FIGS. 9A-D presents the ROCs obtained for inserted code of length 1-10. Naturally, the longer the inserted code is, the easier the detection. FIG. 10A displays the obtained AUC for each of the four quality scores as a function of the insertion length. For simulated backdoors of length 4 and up the obtained AUC is above 0.85.

A possible criticism would be that insertion modifies the length of the object code, which by itself can be an indication for an insertion. The experiment was therefore repeated with code substitution of random consecutive statements instead of code insertion. As can be seen in FIG. 10B, the results are only slightly worse in comparison to code insertion. In both the insertion case and the substitution case, the mean L2 norm seems to slightly outperform the other methods.

### Discussion

The present embodiments provide a completely novel approach that addresses critical cybersecurity concerns. The experiments demonstrate that the method of the present embodiments is both practical and effective.

The network employed combines two BiLSTM networks and a similarity computing network, which was replicated on a grid. The alignment net is a simple feed forward network with relatively few parameters. It seems that much of the success stems from the effective representation done by the BiLSTM networks, which process a hybrid statement encoding that was designed. It is therefore evident that the training loss successfully trickles through the architecture to the statement representation layers.

While some embodiments were described in relation to source code compilation at the foundry, other malicious modifications of hardware can also be detected by the technique of the present embodiments. One can only trust hardware in which there exist full functional identity between the designer source, the object resulting from the manufacturer compilation, and the actual silicon implementation. Detection of hardware Trojans is optionally and preferably based on authenticating two or more transfers, preferably every transfer, along the manufacturing process. The method of the present embodiments can model all these transformations since regardless of the logical form of the function, under the assumption of mapping one statement structure to another such that every statement in the second sequence stems from a single statement in the first sequence, the matching can be learned.

The present embodiments can be used in many code analysis tasks. For example by aligning binary code with recompiled binary code the present embodiments can solve, for example, the task of analyzing executable computer codes as these shift from one version to the next, and the analysis of electronic devices as models are being replaced. The present embodiments can be used for other applications, including, without limitations, static code analysis, compiler verification and program debugging. The present embodiments can be used for matching two binary codes that represent the same program but were compiled differently (e.g., by different compilers, using different compilation flags, using different target architecture, etc.). The present embodiments can also be used for comparing between two uncompiled source codes, e.g., codes written in different programming languages. This is particularly useful when one of the codes is a translation of the other, in which case the present embodiments can determine the accuracy of the translation. The present embodiments can also be used for inspecting the dynamic behavior of a system and align it with the static code.

### Example 2

Experiments were preformed according to some embodiments of the present invention and included both artificial and human-written code, and show that our neural network architecture is able to predict the alignment of source and object code statements with high accuracy.

During compilation, source code typically written in a human-readable high level programming language, such as C, C++ and Java, is transformed by the compiler to object code. Every object code statement stems from a specific location in the source code and there is a statement-level alignment between source code and object code.

The deep neural network solution of the present example combines one embedding and one RNN per input sequence, a CNN applied to a grid of sequence representation pairs and multiple softmax layers.

Training was performed using both real-world and synthetic data that we created for this purpose. The real-world data consists of 53,000 functions from 90 open-source projects of the GNU project. Three levels of compiler optimization are tested and the ground truth alignment labels are extracted from the compiler's output.

The network architecture of the present example was challenged with a difficult alignment problem, which has unique characteristics: the input sequences' representations are not per token, but per statement (a subsequence of tokens). The alignment is predicted by our architecture not sequentially (e.g., by employing attention), but by considering the entire grid of potential matches at once. This is done using an architecture that combines a top-level CNN with LSTMs.

### The Code Alignment Problem

A source code written in the C programming language, in which statements are generally separated by a semicolon (;) is considered. The compiler translates the source code to object code. For example, the GCC compiler is used. In order to promote readability, the object code is viewed as assembly, where each statement contains an opcode and its operands. Since the source code is translated to object code during compilation, there is a well-defined alignment between them, which is known to the compiler. GCC outputs this information when it runs with a debug configuration.

In the GCC alignment output, the statement level alignment between source- and object-code is a many-to-one map from object code statements to source code statements: while every object-code statement is aligned to some source-code statement, not all source-code statements are covered. This is due to optimization performed by the compiler. The definition of a statement is therefore slightly modified, in order to support the convention implemented within the GCC compiler. A C statement can be one of the following: (i) a simple statement in C containing one command ending with a semicolon; (ii) curly parentheses ({,}); (iii) the signature of a function; (iv) one of if(EXP1), for(EXP1;EXP2;EXP3), or while(EXP1), including the corresponding expressions; (v) else or do.

The object code statements follow the conventional definition, as describe in Example 1, above.

The matrix representation is the target value of the neural alignment network. The network outputs the rows of the alignment matrix as vectors of pseudo probabilities. The resulting prediction matrix can be viewed as a soft-alignment. In order to obtain hard alignments, take the index of the maximal element in each row can be taken.

Compilation optimization changes the object code based on the level of optimization used. This optimization makes the object code more efficient and can render it shorter (more common) or longer than the code without optimization.

### The Neural Alignment Network

Each statement is treated as a sequence of tokens, where the last token of each such sequence is always the end-of-statement (EOS) token. A function is given by concatenating all such sequences to one sequence.

In this Example, a compound deep neural network was employed for predicting the alignment. It consisted of four parts. A first part was used for representing each source code statement j as a vector vⱼ. A second part did the same for the object code, resulting in a representation vector uᵢ. A third part processed, using a convolutional neural network, pairs of vector representations, one of each type, as a multi-channel grid, and produced a matching score s(i,j). In this example, this matching score was not a probability, but the higher the matching value, the more likely the two statements were to be aligned. The matching scores were fed to the top-most part of the network, which computed pseudo probabilities pᵢⱼ of aligning object code statement i to the source code statement j. Specifically, the fourth part considers for an object-code statement i, all possible source-code matches j=1, 2, . . . , M the matching score, and employs the softmax function:

pᵢⱼ=exp(s(uᵢ,vⱼ))/Σₖ₌₁^{M} exp(s(uᵢ,vₖ)).

### Encoding the Input Statements

The technique of the present example incorporates two LSTM networks to encode the sequences, one for each sequence domain: source code and object code. Therefore, each token in the input sequences is first embedded in a high-dimensional space. Different embedding was used for source code and for object code, since each is composed of a different vocabulary. The vocabularies are hybrid, in the sense that they consist of both words and characters, as explained in Example 1, above.

Similarly, the object code vocabulary is also a hybrid, and contains opcodes, registers and characters of numeric values and is based on the assembly representation of the object code. The opcode of each statement is one out of dozens of possible values. The operands are either registers or numeric values. The vocabulary also includes the punctuation marks of the assembly language and, therefore, contains the following types of elements: (i) the various opcodes; (ii) the various registers; (iii) hexadecimal digits; (iv) the symbols (,),x,-,:; and (v) EOS, which ends every statement.

### Neural Network Architecture

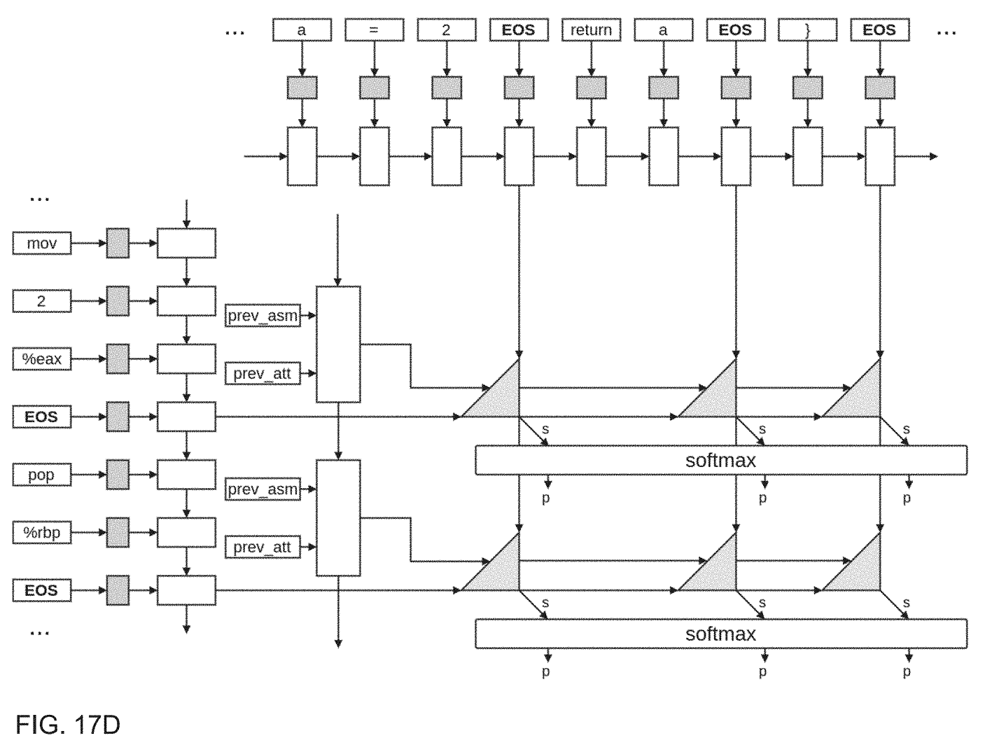

FIGS. 17A-D illustrate various alignment networks, showing three source statements and two assembly statements. The code sequences' tokens are first embedded (gray rectangles). The embedded sequences are then encoded by LSTMs (elongated white rectangles). The statement representations are fed to a decoder (different in every figure) and then the similarities (s) output by the decoder are fed into one softmax layer per each object code statement (rounded rectangles), which generates pseudo probabilities (p). FIG. 17A illustrates a grid decoder, in which the grid of encoded statements is processed by a CNN, according to some embodiments of the present invention. FIGS. 17B-D are described below.

The input sequences introduce many complex and long-range dependencies. Therefore, the network employs two LSTM encoders: one for creating a representation of the source code statements and one is used for representing the object code. In all the experiments of this example, the LSTMs have one layer and 128 cells.

The result of the LSTM encoders are M representation vectors output by the source-code encoding LSTM, denoted by {vⱼ}_{j=1, . . . , M}, and N representation vectors output by the object-code encoding LSTM, denoted by {uᵢ}_{i=1, . . . , N}.

The statement representation vectors are then assembled in an N×M grid, such that the (i,j) element is [uᵢ;vⱼ], where “;” denotes vector concatenation. Since each encoder LSTM has 128 cells, the vector [uᵢ;vⱼ] has 256 channels.

In order to transform the statement representation pairs to matching scores, a decoding CNN over the 256-channel grid was employed. The decoding CNN in this example has five convolutional layers, each with 32 5×5 filters followed by ReLU non-linearities, except for the last layer which consists of one 5×5 filter and no non-linearities. The CNN output was, therefore, a single channel N×M grid, denoted s(i,j), representing the similarity value of object code statement i and source statement j.

In the many-to-one alignment problem, the network's output for each row typically contains pseudo probabilities. Therefore, a softmax layer was added on top of the list of similarity values computed for each object-code statement i: s(uᵢ,v₁), s(uᵢ,v₂), . . . , s(uᵢ,v_{M}), so that there were N softmax layers, each converting M similarity scores to a vector of probabilities {pᵢⱼ}_{j=1, . . . , M} for each row i=1, . . . , N.

During training, a Negative Log Likelihood (NLL) loss was used. Let A be the set of N object-code to source-code matches (i,j). The training loss for a single training sample is given by

(1/N)Σ_{(i,j)∈A}−log(pᵢⱼ),

so that the loss is the mean of NLL values of all N rows.

### Local Grid Decoder

For comparison, a model that performs decoding directly over the statements grid was also considered. In this model, the decoder consists only of a single layer network s attached to each one of the NM pairs of object code and source code statement representations (uᵢ and vⱼ). The same network weights are shared between all NM pairs and are trained jointly. This network is given by:

s(uᵢ,vⱼ)=v^{T} tanh(Wₒuᵢ+Wₛvⱼ)

where v, Wₒ and Wₛ are the network's weights. Another, simpler version of the Local Grid Decoder, was also considered. In this model, an inner product operation is employed, instead of the single layer network: s(uᵢ,vⱼ)=uᵢ^{T} . . . vⱼ.

### Other Baseline Methods

Pointer Network

This baseline adapts the Pointer Network (Ptr-Net) architecture in two ways. Ptr-Net is designed to solve the task of producing a sequence of pointers to an input sequence. The Ptr-Net architecture employs an encoder LSTM to represent the input sequence as a sequence of hidden states eⱼ. A second decoder LSTM then produces hidden states that are used to point to locations in the input sequence via an attention mechanism. Denote the hidden states of the decoder as dᵢ. The attention mechanism is then given by:

uⱼⁱ=v^{T} tanh(W₁eⱼ+W₂dᵢ), j=1, . . . ,n

pᵢ=softmax(uⁱ)

where n is the input sequence length and pᵢ is the soft prediction at time step i of the decoder LSTM. The input to the decoder LSTM at time step i is argmaxⱼ(ujⁱ⁻¹), so that the input token “pointed” by the attention mechanism at the previous step. Thus, the output of the decoder LSTM can be considered as a sequence of pointers to locations at the input sequence.

In this example Ptr-Net was adapted to produce “pointers” to the source code statements sequence for every object code statement. Two such adaptations were created referred to as Ptr1 and Ptr2.

In Ptr1, a Ptr-Net decoder was employed at each time step i over the sequence of object code statement representations uᵢ. The decoder was an LSTM network, whose hidden state hᵢ was fed to an attention model employed over the whole sequence of source code statement representations vᵢ:

s(i,j)=v^{T} tanh(Wₛvⱼ+Wₕhᵢ).

The outputs s(i,j) of the attention model are used as the similarity scores that was fed later to the softmax layers. The Ptr-Net decoder received at each time step i, the source code statement representation that the attention model “pointed” to at the previous step i−1, i.e., vₚ₍ᵢ₋₁₎ where

p(i)=argmaxⱼ(s(i,j)).

In order to condition the output of the pointer decoder at the current object code statement representation uᵢ, the input of the pointer decoder LSTM is the concatenation of uᵢ and vₚ₍ᵢ₋₁₎:

hᵢ=LSTM([uᵢ;vₚ₍ᵢ₋₁₎],hᵢ₋₁,cᵢ,cᵢ₋₁),

where cᵢ is the contents of the LSTM memory cells at time step i.

At the first time step i=1, the value of vₚ₍₀₎ is the all-0 vector, and ho is initialized with the last hidden state of the source-code statements encoding LSTM.

At each step, the Ptr-Net decoder sees the current object code statement and the previous “pointed” source code statement. It means that the LSTM sees the source code statement that is aligned to the previous object code statement. A wiser adaptation would present the Ptr-Net decoder LSTM with the explicit alignment decision, i.e., the previous “pointed” source code statement and the previous object code statement, such that the input is a pair of two statements that were predicted to align. Thus, in the second adaptation of Ptr-Net referred to as Ptr2, the input to the Ptr-Net decoder LSTM was the concatenation of uᵢ₋₁ and vₚ₍ᵢ₋₁₎:

hᵢ=LSTM([uᵢ₋₁;vₚ₍ᵢ₋₁₎],hᵢ₋₁,cᵢ,cᵢ₋₁).

The current object code statement representation uᵢ is then fed directly to the attention model, in addition to the Ptr-Net decoder output and the source code statement representation:

s(i,j)=v^{T} tanh(Wₒuᵢ+Wₛvⱼ+Wₕhᵢ).

At the first time step i=1, the values of vₚ₍₀₎ and ho are initialized as in Ptr1, and u₀ is the all-0 vector.

FIGS. 17B and 17C illustrate the Ptr1 and Ptr2 baselines, respectively, showing the Ptr-Net decoder that processes sequentially the previously pointed source statement and either the current (Ptr1) or previous (Ptr2) assembly statement.

Match-LSTM

This baseline uses the matching scores of the Match-LSTM. The architecture receives as inputs two sentences, a premise and a hypothesis. First, the two sentences are processed using two LSTM networks, to produce the hidden representation sequences vⱼ and uᵢ for the premise and hypothesis, respectively. Next, attention aᵢ vectors are computed over the premise representation sequence as follows: aᵢ=Σₖ₌₁^{M} αᵢⱼvⱼ, where αᵢⱼ are the attention weights and are given by

αᵢⱼ=exp(s(uᵢ,vⱼ))/Σₖ₌₁^{M} exp(s(uᵢ,vₖ))

s(i,j)=v^{T} tanh(Wₒuᵢ+Wₛvⱼ+Wₕhᵢ₋₁),

where hᵢ is the hidden state of the third LSTM that processes the hypothesis representation sequence together with the attention vector computed over the whole premise sequence:

hᵢ=LSTM([uᵢ;aᵢ],hᵢ₋₁,cᵢ,cᵢ₋₁).

In order to adapt Match-LSTM to the alignment problem of the present example, the premise (hypothesis) representation sequence was substituted with the source (object) code statements representation sequence, and the matching scores s(i,j) were used as the alignment scores. this model is similar to Ptr2. The difference is that at each object code statement the decoder LSTM is fed a weighted sum over the source code statement activations, instead of the activation of the last pointed source code statement.

FIG. 17D illustrates the Match-LSTM baseline, showing an LSTM decoder that processes sequentially the current assembly statement and the current attention-weighted sum of source statements. The attention model receives the LSTM output of the previous time step. The Match-LSTM is similar to Ptr2 above, except that instead of pointed source statement it receives the attention-weighted sum of source statements.

### Evaluation

Data Collection

Both synthetic C functions generated randomly and human-written C functions from real-world projects were employed. In order to generate random C code, pyfuzz, an open-source random program generator for python, was modified. In addition to modifying pyfuzz so it outputs programs written in C rather than python, it was also modified such that the code it outputs would consist of one function with the following characteristics: receives five integer arguments; returns an integer result which is the sum of the arguments and local variables; consists of local integer variable declarations, mathematical operations (addition, subtraction and multiplication), for loops, if-else statements and if-else statements nested in for loops.

The reason for the relatively large number of arguments and for returning the sum of all arguments and variables, is the need to avoid code reduction due to compiler optimization. When compiler optimization is activated, operations that have no effect on the returned value are ignored. Returning the sum of all variables and arguments causes each one of them to affect the returned result.

For real-world human-written source code, 90 open-source projects containing over 53,000 functions, that are part of the GNU project and are written in C were used. Among them are bash, make, grep, etc. Before compilation, only the preprocessor of GCC was ran, in order to clean the sources of non-code text, such as comments, macros, #ifdef commands and more.

In order to compile the source code with optimizations, the GCC compiler was used with three of its -O optimization levels, invoked by supplying it with the arguments -O1, -O2 or -O3. Each optimization level turns on many optimization flags. According to the GCC documentation, with -O1, GCC tries to reduce code size and execution time without investing too much compilation time. With -O2, GCC turns on all flags of -O1 level and also performs optimizations that do not involve a space-speed trade-off. This level increases the object code performance. With -O3, GCC turns on all -O2 flags and ten more flags that address relatively rare cases.

Each of the datasets of generated and human-written C functions has three parts, each compiled using one of the three mentioned optimization levels.

After compilation of the human-written projects, some functions contained object code from other, inline functions. These functions were excluded from the dataset in order to introduce the network with pure translation pairs, i.e., source code and object code that has originated entirely from it.

In addition, GCC was instructed to output debugging information that includes the statement-level alignment between each C function and the object code compiled from it. Therefore, each sample in the resulting dataset consists of source code, object code compiled at some optimization level and the statement-by-statement alignment between them. Table 2 reports the statistics of the code alignment datasets.

TABLE 2
Mean ± SD for the two code alignment datasets

| Dataset | #Functions | #Statements per function | #Tokens per stmt |
|---|---|---|---|
| Synthetic. C | 150,000 | 22.8 ± 8.0 | 9.1 ± 8.2 |
| Synth. Asm | 150,000 | 17.1 ± 8.2 | 3.6 ± 2.0 |
| GNU C | 53,118 | 10.5 ± 6.7 | 20.7 ± 16.8 |
| GNU Asm. | 53,118 | 21.2 ± 18.1 | 1.2 ± 1.1 |

Training Procedure

One network was trained for all optimization levels, instead of multiple specialized networks. The lengths of all sequences have been limited to 450 time steps. The training set of generated data contains 120,000 samples. The validation and the test sets contain 15,000 samples each. The training, validation and test sets of human-written functions contain 42,391, 5,474 and 5,253 samples, respectively. During training, batches of 32 samples each were uses.

The weights of the LSTM and attention networks are initialized uniformly in [−1.0,1.0]. The CNN filter weights are initialized using truncated normal distribution with a standard deviation of 0.1. The biases of the LSTM and CNN networks are initialized to 0.0, except for the biases of the LSTM forget gates, which are initialized to 1.0 in order to encourage memorization at the beginning of training. The Adam learning rate scheme was used, with a learning rate of 0.001, β₁=0.9, β₂=0.999, and ε=1E-08.

### Alignment Results

The network of the present embodiments and the baseline methods were trained and evaluated over the datasets of synthetic and human-written code. Table 3 and Table 4, below, present the resulting accuracy, which is computed per object-code statement as follows. First, the network predicts pseudo-probabilities of matching source code statements to each object code statement. Second, in order to obtain hard alignments, the index of the maximal element in each row of the predicted soft alignment matrix is taken. Third, for every object code statement, a true alignment is counted only if the matched source statement is the ground truth matching. The accuracy is reported separately for the three optimization levels and for all of them combined.

TABLE 3
Alignment accuracy results for synthetic code

| Method | -O1 | -O2 | -O3 | All |
|---|---|---|---|---|
| Ptr1 | 99.27% | 98.37% | 98.49% | 98.70% |
| Ptr2 | 99.48% | 98.71% | 98.76% | 98.98% |
| Match-LSTM | 99.21% | 97.98% | 98.25% | 98.46% |
| InnProd Grid | 99.42% | 98.71% | 98.81% | 98.97% |
| Local Grid | 99.47% | 98.75% | 98.83% | 99.02% |
| Conv. Grid | 99.62% | 98.77% | 98.86% | 99.08% |

TABLE 4
Alignment accuracy results for GNU code

| Method | -O1 | -O2 | -O3 | All |
|---|---|---|---|---|
| Ptr1 | 86.90% | 83.45% | 83.77% | 84.91% |
| Ptr2 | 86.21% | 85.48% | 86.35% | 85.95% |
| Match-LSTM | 87.02% | 84.03% | 84.69% | 85.36% |
| InnProd Grid | 88.34% | 88.90% | 90.90% | 89.09% |
| Local Grid | 88.73% | 88.09% | 89.70% | 88.64% |
| Conv. Grid | 91.19% | 90.10% | 91.54% | 90.86% |

As shown in Table 3, all models excel over synthetic code, reaching almost perfect alignment accuracy with a slight advantage to our Convolutional and Local Grid Decoders. Table 4 shows that the GNU code is more challenging to all methods. The Grid Decoder of the present embodiments outperform all baseline methods, and the Convolutional Grid Decoder is superior by a substantial margin over the local and inner product alternatives.

### ANNEX 1

### A Primer on Neural Networks

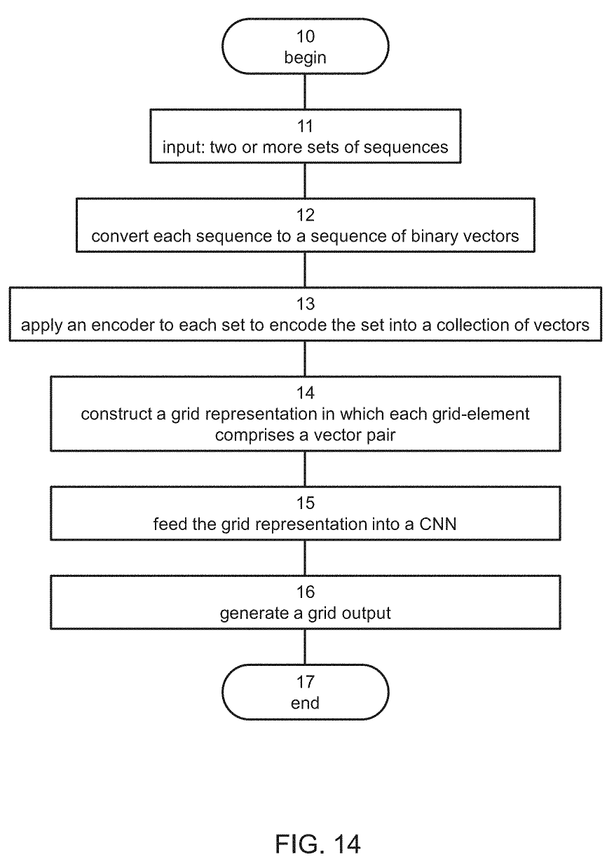

An artificial neuron is the basic unit of the artificial neural network. It performs a simple computation: a dot product of its inputs (a vector x) and a weight vector w. The input is given, while the weights are learned during the training phase and are held fixed during the validation or the testing phase. As shown in FIG. 11, bias is introduced to the computation by concatenating a fixed value of 1 to the input vector creating a slightly longer input vector x, and increasing the dimensionality of w by one. The dot product is followed by a non-linear activation function σ:R→R, and the neuron thus computes the value σw^{T} x). In this work, the sigmoid (logistic) activation function σ(x)=(1+exp(−x))⁻¹ is used.

A neural network architecture (V,E,σ) is determined by a set of neurons V, a set of directed edges E and the activation function σ. In addition, a neural network of a certain architecture is specified by a weight function w:E→R.

In this work three types of network layers are employed (1) feedforward fully connected layers; (2) recurrent layers; and (3) softmax layers.

Feedforward layers have no directed cycles. In typical feedforward networks, the neurons are organized in disjoint layers, V₀, . . . , V_{L}, such that V=Uᵢ₌₁^{L}Vᵢ. The network computes a function that has a dimensionality that is determined by the cardinality of V_{L}. Networks that compute scalar functions have only one neuron in V_{L}. The input layer V₀ holds the input. The other layers are called hidden.

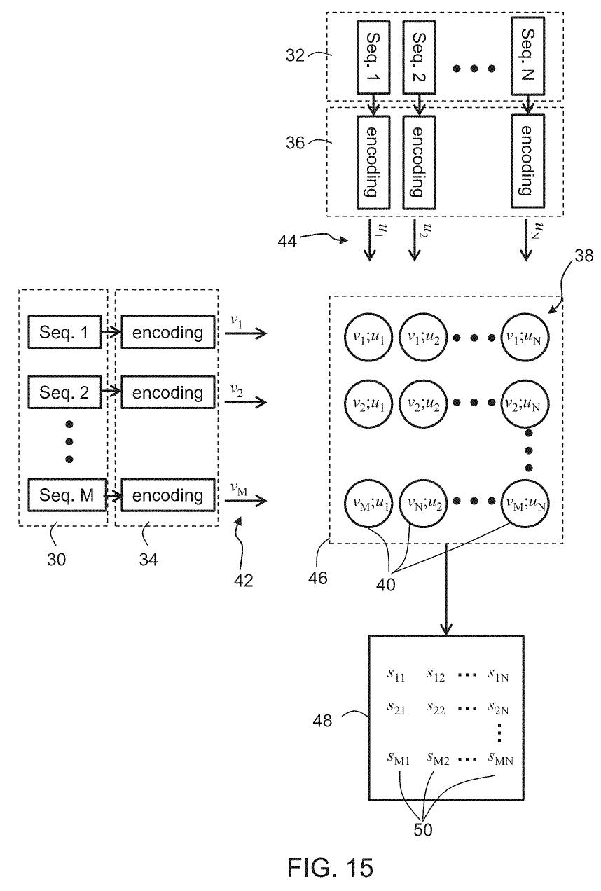

A fully connected neural network is a neural network in which every neuron of layer Vᵢ is connected to every neuron of layer Vᵢ₊₁. In other words, the input of every neuron in layer Vᵢ₊₁ consists of the activation values (the values after the activation function) of all the neurons in the previous layer Vᵢ, see FIG. 12.

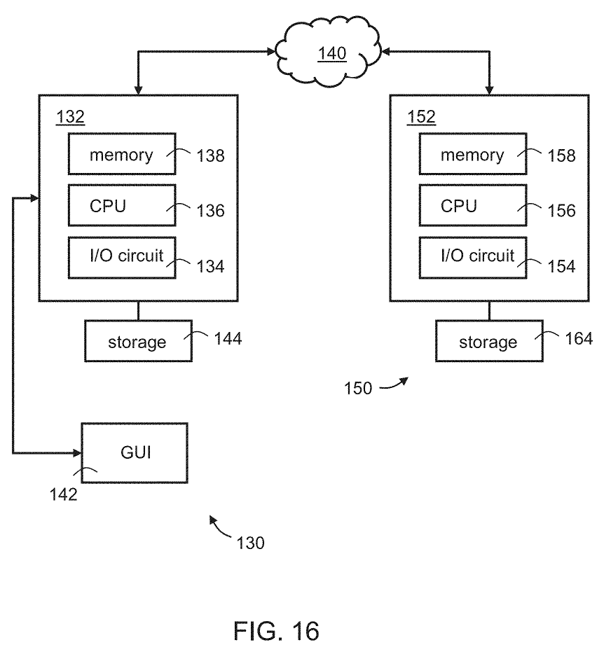

Recurrent Neural Networks (RNNs) are designed to accept sequences of varying lengths as input. The same set of weights are used in the processing of each sequence element. As depicted in FIG. 13A, such networks are also constructed in a layered manner, with an important addition. While in feed forward networks every neuron of layer Vᵢ₊₁ accepts as inputs the activations of all neurons from layer Vᵢ, in RNNs there are also lateral connections with the activations induced at the previous step in the sequence. Specifically, the RNN can be rolled out and layers of neurons Vᵢ^{t}, where i=0 . . . N as before and t=1 . . . K, where K is the length of the sequence can be considered. For every t and every i=0 . . . N−1, all neurons of layer Vᵢ₊₁^{t} are fed the activations of all neurons of layer Vᵢ^{t}. In addition, for every t<K and every i=1 . . . N−1, all neurons of layer Vᵢ^{t+1} obtain the activations of the layer Vᵢ^{t} as inputs.

Bidirectional RNNs are obtained by holding two RNN layers: one going forward, in which Vᵢ^{t} serves as input to Vᵢ^{t+1} and one going in the opposite direction, in which Vᵢ^{t+2} is the input of Vᵢ^{t+1}. These two layers exist in parallel and the activations of both, concatenated, serve as the bottom up input to the layer on top Vᵢ₊₁^{t+1}, see FIG. 13B.

Training of neural networks is done by minimizing a loss function that measures the discrepancy between the network's output and the target output, which is known during the training phase. Often a Stochastic Gradient Descent with minibatches is used. In this method, the training dataset is divided to small, non-overlapping subsets. The gradient of the loss with respect to the network's weights is computed for each minibatch serially, and the current estimate of the network's weights is updated by taking a small step, whose magnitude is determined by the learning rate, in the direction opposite to the gradient. In this annex the Adam method was employed in order to dynamically control an individual learning rate to each of the weights.

The gradient of the network's loss is computed from weights of the topmost layer to the weights multiplying the input layer by using the chain rule. This serial process is called back-propagation. The problem of vanishing gradients in deep neural networks arise when the loss does not tickle down far enough down the network. This occurs very quickly in RNNs, where the signals (gradients) from later steps in the sequence diminish quickly in the back-propagation process, making it hard to capture long-range dependencies in the sequence. The Long Short-Term Memory (LSTM) architecture addresses this problem by employing “memory cells” in lieu of simple activations. Access to the memory cells is controlled by multiplicative factors that are called gating in the Neural Network terminology. At each input state, gates are used in order to decide how much of the new input should be written to the memory cell, how much of the current content of the memory cell should be forgotten, and how much of the content would be outputted. For example, if the output gate is closed (a value of 0), the neurons connected to the current neuron will receive a value of 0. If the output gate is partly open at a gate value of 0.5, the neuron will output half of the current value of the stored memory.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of comparing sequences, the method comprising:
inputting a first set of sequences and a second set of sequences;
applying an encoder to each set to encode said set into a collection of vectors, each representing one sequence of said set;
constructing a grid representation having a plurality of grid-elements, each comprising a vector pair composed of one vector from each of said collections; and
feeding said grid representation into a convolutional neural network (CNN), constructed to simultaneously process all vector pairs of said grid representation, and to provide a grid output having a plurality of grid-elements, each defining a similarity level between vectors in one grid-element of said grid representation.

2. The method of claim 1, wherein said encoder comprises a Recurrent Neural Network (RNN).

3. The method of claim 2, wherein said RNN is a bi-directional RNN.

4. The method according to claim 1, wherein said encoder comprises a long short-term memory (LSTM) network.

5. The method according to claim 1, wherein said CNN comprises a plurality of subnetworks, each being fed by one grid element of said grid representation.

6. The method of claim 5, wherein at least a portion of said plurality of subnetworks are replicas of each other.

7. The method according to claim 1, further comprising concatenating said vector pair to a concatenated vector.

8. The method according to claim 1, further comprising converting each sequence to a sequence of binary vectors, wherein said applying said encoder comprises feeding said binary vectors to said encoder.

9. The method of claim 7, further comprising concatenating said sequence of binary vectors prior to said feeding.

10. The method according to claim 1, wherein said encoder is configured to provide, for each sequence, a single vector corresponding to a single representative token within said sequence.

11. The method according to claim 10, further comprising redefining said first set of sequences and said second set of sequences such that each sequence of each set includes a single terminal token, wherein said single representative token is said single terminal token.

12. The method according to claim 1, wherein each of said first and said second sets of sequences is a computer code.

13. The method according to claim 12, wherein said first set of sequences is a programming language source code, and said second set of sequences is an object code.

14. The method of claim 13, wherein said object code is generated by compiler software applied to said programming language source code.

15. The method of claim 13, wherein said object code is generated by compiler software applied to another programming language source code which includes at least a portion of said programming language source code of said first set of sequences and at least one sub-code not present in said programming language source code of said first set of sequences.

16. The method according to claim 12, wherein said first set of sequences is a first programming language source code, and said second set of sequences is a second programming language source code.

17. The method of claim 16, wherein said second programming language source code is generated by a computer code translation software applied to said first programming language source code.

18. The method according to claim 12, wherein said first set of sequences is a first object code, and said second set of sequences is a second object code.

19. The method of claim 18, wherein said first and said second object code are generated by different compilation processes applied to the same programming language source code.

20. The method according to claim 12, further comprising generating an output pertaining to computer code statements that are present in a computer code forming said second set, but not in a computer code forming said first set.

21. The method according to claim 20, further comprising identifying a sub-code formed by said computer code statements, and wherein said generating said output comprises identifying said sub-code as malicious.

22. A computer software product, comprising a computer-readable medium in which program instructions are stored, which instructions, when read by a data processor, cause the data processor to receive a first set of sequences and a second set of sequences and to execute the method according to claim 1.

23. A system for comparing sequences, the system comprises a hardware processor for executing computer program instructions stored on a computer-readable medium, said computer program instructions comprising:
computer program instructions for inputting a first set of sequences and a second set of sequences;
computer program instructions for applying an encoder to each set to encode said set into a collection of vectors, each representing one sequence of said set;
computer program instructions for constructing a grid representation having a plurality of grid-elements, each comprising a vector pair composed of one vector from each of said collections; and
computer program instructions for feeding said grid representation into a convolutional neural network (CNN), constructed to simultaneously process all vector pairs of said grid representation, and to provide a grid output having a plurality of grid-elements, each defining a similarity level between vectors in one grid-element of said grid representation.
